(19) United States
(12) Patent Application Publication
(10) Pub. No.: US 2025/0314550 A1
(43) Pub. Date: Oct. 9, 2025

(54) SYSTEMS AND METHODS FOR LEAKAGE DETECTION, PREVENTION, AND MITIGATION

(71) Applicant: Kotleak Ltd., Yavne (IL)

(72) Inventors: Yochai Edlitz, Yavne (IL); Ido Kotler, Kfar Saba (IL); Eli Swed, Tel Aviv (IL)

(73) Assignee: Kotleak Ltd., Yavne (IL)

(21) Appl. No.: 18/892,822

(22) Filed: Sep. 23, 2024

Related U.S. Application Data
(60) Provisional application No. 63/575,882, filed on Apr. 8, 2024.

(51) Int. Cl. G01M 3/24; F15B 19/00

(52) U.S. Cl. CPC G01M 3/24; F15B 19/00

(57) ABSTRACT

Disclosed embodiments relate to systems and methods for acoustically detecting leakage of a fluid using one or more acoustic sensors. Techniques include receiving a signal from the one or more acoustic sensors; performing pre-processing on the signal; inputting the pre-processed signal to a machine learning algorithm; receiving, based on the pre-processed signal and the machine learning algorithm, a classification of the pre-processed signal, the classification being associated with an acoustic profile of leakage of a fluid; and providing a prompt associated with the classification to a user device.

### CROSS REFERENCES TO RELATED APPLICATION

This application claims the benefit of priority of U.S. Provisional Application No. 63/575,882, filed Apr. 8, 2024, which is incorporated herein by reference in its entirety.

### BACKGROUND

### Technical Field

The present disclosure relates generally to techniques for detection, prevention, and mitigation of leakages of fluids (e.g., gasses, liquids, etc.), electromagnetic radiation, or other detectable elements.

### Background Information

Use of compressed air in industry and in service sectors is common as its production and handling are safe and easy. In many industrial facilities, compressed air is an integral part of the manufacturing process. Compressed-air generation is, however, energy intensive, and for most industrial operations, the energy cost of compressed air is significant compared with overall energy costs. Annual operating costs of air compressors, dryers, and supporting equipment can account for 70% to 90% of the total electric bill at a given site. Compressed-air systems account for about 10% of total industrial energy use for certain countries and is typically one of the most expensive utilities in an industrial facility.

Leakages in compressed air systems account for significant loss of revenue as well as translate into sizeable energy losses, which may also result in increased emission of greenhouse gases into the atmosphere. Leakages not only of compressed air, but also of other fluids, such as water, oil, and liquid gas, constitute a major challenge across multiple industries, leading to environmental pollution, reduced productivity of machines, and revenue loss. However, most detection methods still rely on periodic human inspections using hand-held equipment with reduced directional resolution. Moreover, monitoring of a large factory floor for small leakages presents several practical challenges that to this day remain inadequately addressed.

The embodiments of the present disclosure address various technical challenges in leakage detection, prevention, and mitigation. As discussed below, the disclosed techniques more accurately, efficiently, and with less effort and complication identify leakages of fluids, electromagnetic radiation, or other phenomena. The disclosed techniques are also able to remedy identified leakages and provide analytics regarding detected leakages. Various exemplary embodiments are disclosed below.

### SUMMARY

The disclosed embodiments describe non-transitory computer readable media, systems, and methods for acoustically detecting leakage of a fluid. For example, in an embodiment, a system for acoustically detecting leakage of a fluid may include one or more acoustic sensors; and at least one processing unit configured to: receive a signal from the one or more acoustic sensors; perform pre-processing on the signal, the pre-processing including at least one of: signal mixing, signal augmentation, signal time characteristic extraction, signal filtration, signal Fourier transformation, feature extraction pipeline, dimensionality reduction mechanism, or signal spectral analysis; input the pre-processed signal to a machine learning algorithm; receive, based on the pre-processed signal and the machine learning algorithm, a classification of the pre-processed signal, the classification being associated with an acoustic profile of leakage of a fluid; and provide a prompt associated with the classification to a user device.

According to a disclosed embodiment, the at least one acoustic sensor is configured to dynamically change its orientation.

According to a disclosed embodiment, the at least one acoustic sensor has a fixed orientation.

According to a disclosed embodiment, the machine learning algorithm comprises a deep learning algorithm.

According to a disclosed embodiment, the machine learning algorithm comprises a decision tree algorithm.

According to a disclosed embodiment, the machine learning algorithm comprises a clustering algorithm.

According to a disclosed embodiment, the machine learning algorithm comprises a dimensionality reduction algorithm.

According to a disclosed embodiment, the machine learning algorithm comprises a classification algorithm.

According to a disclosed embodiment, the machine learning algorithm comprises a reinforcement learning algorithm.

According to a disclosed embodiment, the processing unit is further configured to identify, based on the pre-processed signal and the machine learning algorithm at least one of: a location of the leakage of the fluid or a direction of the leakage of the fluid.

According to a disclosed embodiment, the prompt comprises the at least one of: the location of the leakage of the fluid or the direction of the leakage of the fluid.

According to a disclosed embodiment, the machine learning algorithm is uniquely trained for a particular physical environment.

According to a disclosed embodiment, the machine learning algorithm is a generalized algorithm tuned to a particular physical environment.

According to a disclosed embodiment, the machine learning algorithm is a generalized algorithm not tuned to a particular physical environment.

According to a disclosed embodiment, the prompt is at least one of a message, graphical user interface content, or data sent to a different system.

According to a disclosed embodiment, the processing unit is configured to receive a plurality of signals from a plurality of acoustic sensors.

According to a disclosed embodiment, the processing unit is configured to receive one or more signal from a single acoustic sensor.

According to a disclosed embodiment, the fluid is a pressurized gas.

The disclosed embodiments also describe non-transitory computer readable media, systems, and methods for training a machine learning algorithm to detect leaks of fluids. For example, in an embodiment, a method may include identifying a first dataset comprising first noise data and one or more first parameter associated with a fluid contained within a conduit structure, wherein the one or more first parameter includes at least one of: a diameter of the conduit structure, a pressure of the fluid within the conduit structure, or a type of the fluid within the conduit structure; inputting the first dataset to a machine learning algorithm, wherein the machine learning algorithm is configured to classify the first dataset, wherein available classifications include at least: a leak of the fluid, or a non-leak of the fluid; identifying a second dataset comprising second noise data and one or more second parameter associated with the fluid; and inputting the second dataset to the machine learning algorithm, wherein the machine learning algorithm is configured to classify the second dataset; and updating the machine learning algorithm based on the classifying of the second dataset.

According to a disclosed embodiment, the one or more first parameter includes all of the diameter of the conduit structure, the pressure of the fluid within the conduit structure, and the type of the fluid within the conduit structure.

According to a disclosed embodiment, the one or more first parameter includes a temperature associated with the conduit structure.

According to a disclosed embodiment, the one or more first parameter includes a humidity associated with the conduit structure.

According to a disclosed embodiment, the one or more first parameter includes an ambient noise associated with the conduit structure.

According to a disclosed embodiment, the one or more first parameter includes a time or date.

According to a disclosed embodiment, an estimate of at least one of size or severity of the leak is provided.

The disclosed embodiments also describe non-transitory computer readable media, systems, and methods for training and deploying machine learning models for acoustically detecting leakage of a fluid. For example, in an embodiment, a centralized system for training and deploying machine learning models for acoustically detecting leakage of a fluid may include a processing unit configured to: communicate with a plurality of localized processing units, the plurality of localized processing units being deployed at a plurality of detection sites; receive unique acoustic training data from each of the plurality of detection sites; enrich the unique acoustic training data by associating the unique acoustic training data with one or more unique acoustic leak profiles; incorporate the enriched unique acoustic training data into a machine learning model at the centralized system; develop, based on the enriched unique acoustic training data and the machine learning model, a plurality of customized machine learning models configured to acoustically identify fluid leaks; and send the plurality of customized machine learning models to the plurality of localized processing units for deployment at the plurality of detection sites.

According to a disclosed embodiment, the received unique acoustic training data is unfiltered.

According to a disclosed embodiment, the received unique acoustic training data is filtered before being received at the processing unit.

According to a disclosed embodiment, the deployed plurality of customized machine learning models are configured to further develop based on new unique acoustic training data detected locally at the plurality of detection sites.

According to a disclosed embodiment, the processing unit is configured to, after the deployment of the plurality of customized machine learning models, receive new unique acoustic training data from each of the plurality of detection sites and further update the plurality of customized machine learning models.

According to a disclosed embodiment, the processing unit is configured to send the further updated plurality of customized machine learning models to the plurality of localized processing units for deployment at the plurality of detection sites.

According to a disclosed embodiment, each of the plurality of customized machine learning models is different from each other.

According to a disclosed embodiment, each of the plurality of customized machine learning models is a refined model based on a default model.

The disclosed embodiments also describe non-transitory computer readable media, systems, and methods for deploying a federated architecture for training machine learning models for acoustically detecting leakage of a fluid. For example, in an embodiment, a system for deploying a federated architecture for training machine learning models for acoustically detecting leakage of a fluid may include a centralized processing unit configured to: configure a default machine learning model that is configured to, upon training, detect leakage of a fluid; allow a model to be trained across multiple decentralized edge devices or servers holding local data samples, without exchanging them wherein each detection site is configured to: store its respective instance of the default machine learning model, receive unique acoustic training data at its detection site, train its respective instance of the default machine learning model based on the received unique acoustic training data, and operate in real-time to detect leakage of a fluid at its detection site based on its respective trained machine learning model.

According to a disclosed embodiment, each detection site is configured to use its respective trained machine learning model and newly received data to provide an updated classification suited to each detection site environment.

According to a disclosed embodiment, the received unique acoustic training data is not received at the centralized processing unit.

According to a disclosed embodiment, the newly detected noise is not received at the centralized processing unit.

According to a disclosed embodiment, the centralized processing unit is further configured to receive from the plurality of localized processing units parameters of each respective trained machine learning model.

According to a disclosed embodiment, the centralized processing unit is further configured to update the mutual central machine learning model based on at least some of the received parameters.

According to a disclosed embodiment, the centralized processing unit is further configured to transmit a plurality of instances of the updated default machine learning model to the plurality of localized processing units.

The disclosed embodiments also describe non-transitory computer readable media, systems, and methods for deploying remotely trained machine learning models for acoustically detecting leakage of a fluid. For example, in an embodiment, a localized system for deploying remotely trained machine learning models for acoustically detecting leakage of a fluid may include a processing unit configured to: deploy a local version of a machine learning model, the local version being configured to acoustically detect leaks of fluids; receive unique acoustic training data from a physical environment local to the localized system; filter a portion of the unique acoustic training data based on a data privacy criterion; send the filtered portion of the unique acoustic training data to a centralized training resource, the centralized training resource being separate from the localized system, wherein to centralized training resource is configured to: incorporate the filtered portion of the unique acoustic training data into a centralized version of the machine learning model, and update, based on the filtered portion of the unique acoustic training data, the machine learning model, to create an updated instance of the machine learning model, and send the updated instance of the machine learning model to the localized system; and deploy the updated instance of the machine learning model in the physical environment to acoustically detect leaks of fluids in real time.

According to a disclosed embodiment, the data privacy criterion is defined as a range of frequencies associated with human voice.

According to a disclosed embodiment, the data privacy criterion is defined as detected instances of human voice in the unique acoustic training data.

According to a disclosed embodiment, the data privacy criterion is defined as portions of the unique acoustic training data above an amplitude threshold.

The disclosed embodiments also describe non-transitory computer readable media, systems, and methods for acoustically detecting leakage of a fluid based on a plurality of diverse sensors. For example, in an embodiment, a system for acoustically detecting leakage of a fluid based on a plurality of diverse sensors may include: a first sensor comprising an acoustic sensor a second sensor that is not an acoustic sensor; and at least one processing unit configured to: receive a first signal from the first sensor and a second signal from the second sensor; provide an input to a machine learning algorithm, the input being based on at least the first signal and the second signal; receive, based on the first signal, the second signal, and the machine learning algorithm, a classification, the classification being associated with an acoustic profile of leakage of a fluid; and providing a prompt associated with the classification to a user device.

According to a disclosed embodiment, the second sensor is an accelerometer.

According to a disclosed embodiment, the second sensor is a gas detection sensor.

According to a disclosed embodiment, the second sensor is a thermometer.

According to a disclosed embodiment, the at least one processing unit is further configured to identify, based on the first signal, the second signal, and the machine learning algorithm, at least one of: a location of the leakage of the fluid or a direction of the leakage of the fluid.

According to a disclosed embodiment, both of the first sensor and the second sensor are positioned external to an object being monitored for fluid leakage.

According to a disclosed embodiment, at least one of the first sensor and the second sensor are positioned internal to an object being monitored for fluid leakage.

The disclosed embodiments also describe non-transitory computer readable media, systems, and methods for detecting electromagnetic leakage or anomalies. For example, in an embodiment, a detection system for detecting electromagnetic leakage or anomalies may include: a detection unit comprising at least one electromagnetic radiation sensor; and a processing unit configured to: receive a signal from the detection unit corresponding to detected electromagnetic radiation over time; provide the received signal to a trained machine learning model, the trained machine learning model being configured with a plurality of trained detection patterns comprising at least: an electromagnetic leakage pattern, and an electromagnetic baseline pattern; determine, based on the received signal and the trained machine learning model, at least one of: a correlation between the received signal and the electromagnetic leakage pattern, or a deviation between the received signal and the electromagnetic baseline pattern; and provide a prompt associated with the correlation or deviation to a user device.

According to a disclosed embodiment, the detection system is configured for affixing on an electrical device.

According to a disclosed embodiment, the detection system is configured for placement in proximity to an electrical device.

According to a disclosed embodiment, the electromagnetic leakage pattern is unique to a particular electrical device.

According to a disclosed embodiment, the electromagnetic baseline pattern is developed based on monitoring a particular electrical device.

According to a disclosed embodiment, the electromagnetic baseline pattern is developed based on monitoring a plurality of electrical devices.

According to a disclosed embodiment, the prompt identifies a particular electrical device being monitored.

According to a disclosed embodiment, the prompt identifies a physical location of an electrical device being monitored.

According to a disclosed embodiment, the prompt identifies a determined potential cause of a potential electromagnetic leakage or electromagnetic fault.

The disclosed embodiments also describe non-transitory computer readable media, systems, and methods for mobile systems acoustically detecting leakage of a fluid. For example, in an embodiment, a mobile system for acoustically detecting leakage of a fluid may include: a body having one or more movement mechanisms, the one or more movement mechanisms comprising: a propeller, a wheel, a track, or a suction cup; and a power source to provide power for the one or more movement mechanisms; at least one acoustic sensor configured together with the body; at least one processing unit configured to: instruct the body to move via at least one of the one or more movement mechanisms; receive a signal from the at least one acoustic sensor; and provide the signal to a machine learning algorithm; wherein the machine learning algorithm is configured to identify a classification of the signal, the classification being associated with an acoustic profile of leakage of a fluid.

According to a disclosed embodiment, the machine learning algorithm is implemented locally by the at least one processing unit.

According to a disclosed embodiment, the machine learning algorithm is implemented remotely by a device separate from the at least one processing unit.

According to a disclosed embodiment, the at least one processing unit is configured to provide a prompt associated with the classification to a user device.

According to a disclosed embodiment, the instruction for the body to move is an instruction to periodically move in a defined environment.

According to a disclosed embodiment, the instruction for the body to move is an instruction to move toward an object.

According to a disclosed embodiment, the instruction for the body to move is an instruction to move toward a noise source using a gradient descent method.

According to a disclosed embodiment, the at least one acoustic sensor is affixed externally to the body.

According to a disclosed embodiment, the at least one acoustic sensor is affixed internally to the body.

The disclosed embodiments also describe non-transitory computer readable media, systems, and methods for conduit objects configured to contain or transport a fluid. For example, in an embodiment, a conduit object configured to contain or transport a fluid may comprise: an integrated sensor device affixed within the conduit object; and at least one processing unit configured to: receive a signal from the integrated sensor device; and provide the signal to a machine learning algorithm; wherein the machine learning algorithm is configured to identify a classification of the signal, the classification being associated with a profile of leakage of a fluid.

According to a disclosed embodiment, the machine learning algorithm is implemented locally by the at least one processing unit.

According to a disclosed embodiment, the machine learning algorithm is implemented remotely by a device separate from the at least one processing unit.

According to a disclosed embodiment, the fluid is a gas and the integrated sensor device is an acoustic sensor.

According to a disclosed embodiment, the fluid is a gas and the integrated sensor device is an accelerometer.

According to a disclosed embodiment, the fluid is a liquid and the integrated sensor device is an accelerometer.

According to a disclosed embodiment, the conduit object may further comprise a power source configured to power the at least one processing unit.

According to a disclosed embodiment, the power source generates power from a movement of the fluid within the conduit object.

The disclosed embodiments also describe non-transitory computer readable media, systems, and methods for visually representing data associated with leakage of a fluid. For example, in an embodiment, a computer-implemented method for visually representing data associated with leakage of a fluid may comprise: receiving a signal from at least one acoustic sensor in a physical environment; inputting the signal to a trained machine learning algorithm; receiving, based on the signal and the trained machine learning algorithm, a classification of the signal, the classification being associated with an acoustic profile of leakage of a fluid; referencing location information associated with the at least one acoustic sensor in the physical environment; and providing a prompt associated with the classification and identifying a particular location in the physical environment to a user device.

According to a disclosed embodiment, the location information is based on a digital twin of the physical environment.

According to a disclosed embodiment, the location information comprises a two-dimensional map of the physical environment.

According to a disclosed embodiment, the location information comprises a three-dimensional map of the physical environment.

According to a disclosed embodiment, the location information comprises a predetermined location of the at least acoustic sensor.

According to a disclosed embodiment, the prompt identifies a type of fluid being leaked.

According to a disclosed embodiment, the prompt identifies a time the leak began.

According to a disclosed embodiment, the prompt identifies a determined root cause of the leak.

According to a disclosed embodiment, the determined root cause is at least one of: corrosion, puncture, disconnection, or incomplete connection.

The disclosed embodiments also describe non-transitory computer readable media, systems, and methods for enhancing sensor placement in a physical environment. For example, in an embodiment, a computer-implemented method for enhancing sensor placement in a physical environment may comprise: identifying an initial position of at least one sensing unit; defining a performance constraint and objective for the sensing unit; and performing a performance analysis for a physical environment using a trained machine learning algorithm based on the performance constraint and the objective, the performance analysis determining a new position for placement of at least one sensing unit; wherein the performance constraint and the objective are associated with a particular type of fluid and a particular type of pipe carrying the fluid.

According to a disclosed embodiment, the method may further comprise simulating a detection profile for a sensor located at the new position.

According to a disclosed embodiment, the method may further comprise validating the new position by collecting experimental data and comparing it with the simulated detection profile.

According to a disclosed embodiment, the at least one sensing unit comprises at least one of: an accelerometer, an acoustic sensor, or an electromagnetic sensor.

The disclosed embodiments also describe non-transitory computer readable media, systems, and methods for early and preventative acoustic detection of leakage of a fluid. For example, in an embodiment, a system for early and preventative acoustic detection of leakage of a fluid may include: at least one acoustic sensor; and at least one processing unit configured to: receive a signal from the at least one acoustic sensor; input the signal to a trained machine learning algorithm; receive, based on the signal and the trained machine learning algorithm, a classification of the signal, the classification being an acoustic pattern of a pre-leak of a fluid contained within a conduit structure; wherein the trained machine learning algorithm is configured to correlate the signal with a subsequent emergence of an actual leak; and provide a prompt identifying the pre-leak to a user device.

According to a disclosed embodiment, the machine learning model is configured to predict plurality of actual leaks from a plurality of signals.

According to a disclosed embodiment, the prompt identifies an amount of time since the pre-leak began.

According to a disclosed embodiment, the prompt estimates an amount of time until the pre-leak will emerge into an actual leak.

According to a disclosed embodiment, the prompt identifies a location in a physical environment of the pre-leak.

According to a disclosed embodiment, the prompt identifies a type of fluid associated with the pre-leak.

According to a disclosed embodiment, the prompt identifies a type of the conduit structure.

According to a disclosed embodiment, the system provides information regarding at least one of: the predicted time to failure, estimated leak occurrence probability or estimated leak severity.

The disclosed embodiments also describe non-transitory computer readable media, systems, and methods for acoustically detecting anomalies in physical environments. For example, in an embodiment, a system for acoustically detecting anomalies in physical environments may comprise: at least one acoustic sensor; and at least one processing unit configured to: receive a signal from the at least one acoustic sensor; perform pre-processing on the signal, the pre-processing including at least one of: signal mixing, signal augmentation, signal time characteristic extraction, signal filtration, signal Fourier transformation, signal spectral analysis, or signal dimensionality reduction; input the pre-processed signal to a machine learning algorithm; receive, based on the pre-processed signal and the machine learning algorithm, a classification of the pre-processed signal, the classification being associated with an acoustic profile of an anomaly in a physical environment; and provide a prompt associated with the classification to a user device.

According to a disclosed embodiment, the anomaly in the physical environment is determined based on rotations of a rotating machine.

According to a disclosed embodiment, the anomaly in the physical environment is determined based on starting or stopping of a machine.

According to a disclosed embodiment, the anomaly in the physical environment is determined based on a duration of operation of a machine.

According to a disclosed embodiment, the anomaly in the physical environment is determined based on a sound deviating from a baseline sound profile associated with a machine.

The disclosed embodiments also describe non-transitory computer readable media, systems, and methods for remedying leakage of a fluid. For example, in an embodiment, a system for remedying leakage of a fluid may include: a repair module configured for physically repairing leaks of fluids; at least one acoustic sensor; and at least one processing unit configured to: receive a signal from the at least one acoustic sensor; provide the signal to a machine learning algorithm configured to acoustically detect leaks of fluids; identify, based on the signal and the machine learning algorithm, a classification of the signal, the classification being associated with an acoustic profile of leakage of a fluid; and instruct the repair module to perform a repair operation based on the classification.

According to a disclosed embodiment, the repair module is configured to apply an epoxy.

According to a disclosed embodiment, the repair module is configured to apply an adhesive.

According to a disclosed embodiment, the repair module is configured to apply nanoparticles.

According to a disclosed embodiment, the nanoparticles are plastics.

According to a disclosed embodiment, the nanoparticles are fluids.

According to a disclosed embodiment, the repair module is integrated into a housing containing the at least one acoustic sensor.

According to a disclosed embodiment, the repair module is contained in a housing separate from the at least one acoustic sensor.

The disclosed embodiments also describe non-transitory computer readable media, systems, and methods for acoustically detecting a size or shape of a leakage of a fluid. For example, in an embodiment, a system for acoustically detecting a size or shape of a leakage of a fluid may comprise: at least one acoustic sensor; and at least one processing unit configured to: receive a signal from the at least one acoustic sensor; perform pre-processing on the signal, the pre-processing including at least one of: signal mixing, signal augmentation, signal time characteristic extraction, signal filtration, signal Fourier transformation, signal spectral analysis, or signal dimensionality reduction; input the pre-processed signal to a machine learning algorithm; receive, based on the pre-processed signal and the machine learning algorithm, a classification of the pre-processed signal, the classification being associated with an acoustic profile of leakage of a fluid; receive, based on the pre-processed signal and the machine learning algorithm, a classification of a size or shape of a leakage of a fluid; and provide a prompt associated with the acoustic profile and the size or shape to a user device.

According to a disclosed embodiment, the size is a diameter.

According to a disclosed embodiment, the size is an area.

According to a disclosed embodiment, the shape is at least one of: crack, puncture, or full break.

According to a disclosed embodiment, the processor is further configured to estimate a volume of the leakage of the fluid.

According to a disclosed embodiment, the estimating is based on a time parameter and one of the size or shape.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an example environment for leakage detection, consistent with the disclosed embodiments.

FIG. 2 illustrates an example conduit system for leakage detection, consistent with the disclosed embodiments.

FIG. 3 illustrates an example system block diagram for acoustic leakage detection, consistent with the disclosed embodiments.

FIG. 4 illustrates an example process for acoustic leakage detection, consistent with the disclosed embodiments.

FIG. 5 illustrates an example environment for leakage detection, consistent with the disclosed embodiments.

FIG. 6 illustrates an example process for training a machine learning model to classify acoustic data, consistent with the disclosed embodiments.

FIG. 7 illustrates an example process for updating a machine learning model, consistent with the disclosed embodiments.

FIG. 8 illustrates an example process for fluid leakage classification, consistent with the disclosed embodiments.

FIG. 9 illustrates an example centralized system environment for leakage detection, consistent with the disclosed embodiments.

FIG. 10 illustrates an example process for centralized leakage detection model development, consistent with the disclosed embodiments.

FIG. 11 illustrates an example decentralized system environment for leakage detection, consistent with the disclosed embodiments.

FIG. 12 illustrates an example process for decentralized leakage detection model development, consistent with the disclosed embodiments.

FIG. 13 illustrates an example system environment for data privacy and leakage detection, consistent with the disclosed embodiments.

FIG. 14 illustrates an example process for data privacy and leakage detection, consistent with the disclosed embodiments.

FIG. 15 illustrates an example process block diagram for leakage detection, consistent with the disclosed embodiments.

FIG. 16 illustrates an example process for leakage detection, consistent with the disclosed embodiments.

FIG. 17 illustrates an example process block diagram for electromagnetic leakage detection, consistent with the disclosed embodiments.

FIG. 18 illustrates an example process for electromagnetic leakage detection, consistent with the disclosed embodiments.

FIG. 19 illustrates an example system environment for mobile leakage detection, consistent with the disclosed embodiments.

FIG. 20 illustrates an example process block diagram for mobile leakage detection, consistent with the disclosed embodiments.

FIG. 21 illustrates an example process for mobile leakage detection, consistent with the disclosed embodiments.

FIG. 22 illustrates an example system environment for leakage classification, consistent with the disclosed embodiments.

FIG. 23 illustrates an example process block diagram for leakage classification, consistent with the disclosed embodiments.

FIG. 24 illustrates an example process for leakage classification, consistent with the disclosed embodiments.

FIG. 25 illustrates an example process for leakage localization, consistent with the disclosed embodiments.

FIG. 26 illustrates an example system environment for leakage detection sensor placement, consistent with the disclosed embodiments.

FIG. 27 illustrates an example process for leakage detection sensor placement, consistent with the disclosed embodiments.

FIG. 28 illustrates an example system environment for improved leakage detection sensor placement, consistent with the disclosed embodiments.

FIG. 29 illustrates example pre-leakage detection signal-to-intensity graphs, consistent with the disclosed embodiments.

FIG. 30 illustrates an example process for pre-leakage detection, consistent with the disclosed embodiments.

FIG. 31 illustrates an example process block diagram for repairing leakages, consistent with the disclosed embodiments.

FIG. 32 illustrates an example process for repairing leakages, consistent with the disclosed embodiments.

FIG. 33 illustrates example process for determining estimated classifications of leakages, consistent with the disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

The techniques for detecting leakages of fluids, electromagnetic fields, and other phenomena described herein overcome several technological problems relating to enhancing energy efficiency in buildings and other facilities, reducing the dangers arising from leakages, strengthening data privacy, and facilitating leakage repair or prevention. As discussed above, leakages of fluids (e.g., gas, liquid, etc.), electromagnetic fields, and the like account for vast amounts of wasted energy across nearly all sectors of the economy. Leakages of these types also pose dangers to health and property since leakages can result in hazardous chemicals being emitted, hot or cold fluids escaping, equipment malfunctioning or breaking, pipes breaking or exploding, machines overheating, and more. Existing techniques for addressing leakages rely on labor-intensive and error-prone manual inspections. There are great technological needs in the art for improvements to address these problems. The various technical solutions described below enable accurate detection of leakages, estimations of forecasted leakages expected to occur in the future, determinations of sizes or shapes of leakages, ascertaining the root causes of leakages, embedding of leakage detection equipment within conduits, determining the optimal placement of leakage detection sensors, remedying leakages, and more.

Reference will now be made in detail to the disclosed embodiments, examples of which are illustrated in the accompanying drawings.

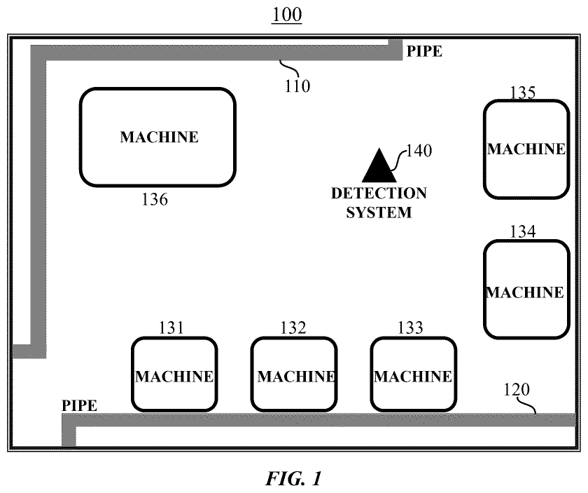

FIG. 1 illustrates an example environment 100 for leakage detection, consistent with the disclosed embodiments. As disclosed herein, environment 100 may represent various forms of facilities or sites where fluids are used or carried. For example, environment 100 may represent a manufacturing site, a materials processing site, a mining site, a repair site, an office building, a multi-tenant dwelling, a home, a laboratory, a school, a retail location, or more. In various types of environment 100, pipes or other types of conduits 110, 120 may carry fluids for operations such as heating, cooling, pressurization, depressurization, controlled disbursement, fire control, manufacturing, transport, and more. As an example, conduit 110 may supply pressurized nitrogen to machine 136 while conduit 120 may supply pressurized oxygen to machines 131, 132, 133, 134, and 135. Machines 131-136 may be various types of devices such as manufacturing equipment, refining equipment, processing equipment, repair equipment, appliances, heating or cooling systems, laboratory devices, or the like.

In various embodiments, conduits 110, 120 may carry unpressurized fluids, depressurized fluids, or pressurized fluids. For example, in some embodiments a compressor, fan, impeller, blower, or pump, or the like, may be utilized to achieve pressurization of a fluid (e.g., gas, liquid, etc.) in conduits 110, 120. Similarly, an expander, turbine, or the like may be used to achieve depressurization of a fluid in conduits 110, 120. Further, conduits 110, 120 may carry unpressurized fluids (e.g., those having an ambient or unaltered pressure). Conduits 110, 120 may be composed of various materials, such as copper, iron, steel, carbon steel, cement, brass, cupronickel, polyvinyl chloride (PVC), chlorinated poly-vinyl chloride (CPVC), polyethylene, cross-linked polyethylene (PEX), polypropylene, polyolefin, acrylonitrile butadiene styrene (ABS), fibre-reinforced plastic, and the like.

Leaks in conduits 110, 120 may occur in various ways. For example, leaks may result from excessive pressure of a fluid, a broken or faulty seal or sleeve, corrosion of conduits 110, 120, cracks or holes in conduits 110, 120, loose connections of conduits 110, 120, open or defective faucets or nozzles, damaged joints of conduits 110, 120, excessive heat or cold, and various other circumstances. When such leaks occur, numerous problems and safety risks arise. As discussed above, leaks cause energy waste, material waste, hazards to humans and property, and downtime for humans and machines.

To address the technical challenges associated with leakage detection, prediction, and remediation, system 100 also includes detection system 140. As discussed herein, detection system 140 may include one or more sensors and one or more processors. In some embodiments, the sensors of detection system 140 may be microphones (e.g., micro-electro-mechanical system (MEMS), condenser, electret condenser, dynamic, ribbon, etc.). Alternatively, the sensors of detection system 140 may be light-based sensors (e.g., photosensors), electromagnetic sensors, induction coils, hall sensors, giant magnetoresistance (GMR) sensors, anisotropic magnetoresistance (AMR) sensors, pressure sensors, ultrasound sensors, humidity sensors, accelerometers, gyroscopes, flex sensors, color sensors, smoke sensors, and various others. In some embodiments, these sensors may be integrated onto, or within, machines 131-136. In other embodiments, the sensors may be placed in environment 100 in proximity to conduits 110, 120 so that they may be able to detect (e.g., acoustically, optically, etc.) leakages in conduits 110, 120. In further embodiments, as discussed below, the sensors may be placed on moving or mobile robotic devices that may traverse conduits 110, 120, adjust locations with respect to conduits 110, 120, or otherwise move in environment 100.

The one or more processors of detection system 140 may be a microprocessor, embedded processor, or the like, or may be integrated in a system on a chip (SoC). According to some embodiments, the one or more processor may be from the family of processors manufactured by Intel®, AMD®, Qualcomm®, Apple®, NVIDIA®, or the like. The one or more processor may also be based on the ARM architecture, a mobile processor, or a graphics processing unit, etc. The disclosed embodiments are not limited to any type of processor configured as the one or more processor.

Detection system 140 may operate with an integrated machine learning or artificial intelligence model, or may communicate with a separate analytical system running a machine learning or artificial intelligence model. In embodiments discussed further below, the machine learning or artificial intelligence model, whether integrated or separate, may enable detection system 140 to identify or predict leakages in conduits 110, 120. Further, in additional embodiments discussed below, the machine learning or artificial intelligence model of detection system 140 may allow for determinations of the size or shape or a leak, the root cause of a leak, improved placement locations for sensors, techniques for remedying a leak, or the like.

The machine learning algorithms used by or with detection system 140 (also referred to as artificial intelligence) may be trained and employed for the purposes of analyzing sound profiles (e.g., detected frequencies and/or amplitudes) captured from acoustic sensors, or non-acoustic data from other sensors, and detecting leaks or anomalies of fluids. Such algorithms may be trained using training examples, such as described below. Some non-limiting examples of such machine learning algorithms may include classification algorithms, data regressions algorithms, acoustic segmentation algorithms, acoustic detection algorithms, auditory recognition algorithms, speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth.

For example, a trained machine learning algorithm may comprise an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes, and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. The result may be, for example, an exact match or classification, an approximate match or classification, or a probability of a match or classification, among other possible results. In some examples, a machine learning algorithm may have parameters and hyper-parameters, where the hyperparameters may be set manually by a person or automatically by a process external to the machine learning algorithm (such as a hyper-parameter search algorithm), and the parameters of the machine learning algorithm may be set by the machine learning algorithm according to the training examples. In some implementations, the hyper-parameters may be set according to the training examples and the validation examples, and the parameters may be set according to the training examples and the selected hyper-parameters.

In some embodiments, trained machine learning algorithms (e.g., artificial intelligence algorithms) may be used to analyze inputs and generate outputs, for example in the cases described below. In some examples, a trained machine learning algorithm may be used as an inference model that, when provided with an input, generates an inferred output. For example, a trained machine learning algorithm may include a classification algorithm, the input may include a sample, and the inferred output may include a classification of the sample (such as an inferred label, an inferred tag, and so forth). In another example, a trained machine learning algorithm may include a regression model, the input may include a sample, and the inferred output may include an inferred value for the sample. In yet another example, a trained machine learning algorithm may include a clustering model, the input may include a sample, and the inferred output may include an assignment of the sample to at least one cluster. In an additional example, a trained machine learning algorithm may include a classification algorithm, the input may include an acoustic profile or segment, and the inferred output may include a classification of a sound, a source of a sound, a type of a sound, etc. In yet another example, a trained machine learning algorithm may include a regression model, the input may include an acoustic profile or segment, and the inferred output may include an inferred value for an item depicted in the sound. In an additional example, a trained machine learning algorithm may include an acoustic segmentation model, the input may include an acoustic profile or segment, and the inferred output may include a segmentation of the sound. In yet another example, a trained machine learning algorithm may include an object detector, the input may include an acoustic profile or segment, and the inferred output may include one or more detected objects or elements in the sound and/or one or more locations of objects or elements within the acoustic profile or segment. In some examples, the trained machine learning algorithm may include one or more formulas and/or one or more functions and/or one or more rules and/or one or more procedures. The input may be used as input to the formulas and/or functions and/or rules and/or procedures, and the inferred output may be based on the outputs of the formulas and/or functions and/or rules and/or procedures (for example, selecting one of the outputs of the formulas and/or functions and/or rules and/or procedures, using a statistical measure of the outputs of the formulas and/or functions and/or rules and/or procedures, and so forth).

In some embodiments, artificial neural networks may be configured to analyze inputs and generate corresponding outputs. Some non-limiting examples of such artificial neural networks may comprise shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long short term memory artificial neural networks, transformer based networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

In some embodiments, detection system 140 may also include signal processing or preprocessing circuitry. For example, this may enable detection system 140 to analyze sound data (or other signals, as described herein) to obtain preprocessed sound data, and subsequently analyze the sound data and/or the preprocessed sound data to obtain the desired outcome. One of ordinary skill in the art will recognize that the following are examples, and that the sound data may be preprocessed using other kinds of preprocessing methods. In some examples, the sound data may be preprocessed by transforming the sound data using a transformation function to obtain a transformed sound data, and the preprocessed sound data may include the transformed sound data.

For example, the transformed sound data may include one or more convolutions of the sound data. Further, the transformation function may comprise one or more sound filters, such as low-pass filters, high-pass filters, band-pass filters, all-pass filters, and so forth. In some examples, the transformation function may include a nonlinear function. Further, the sound data may be preprocessed by smoothing at least parts of the sound data, for example using Gaussian convolution, using a median filter, and so forth. In other examples, the sound data may be preprocessed to obtain a different representation of the sound data. For example, the preprocessed sound data may include: a representation of at least part of the sound data in a frequency domain; a Discrete Fourier Transform of at least part of the sound data; a Discrete Wavelet Transform of at least part of the sound data; a time/frequency representation of at least part of the sound data; a representation of at least part of the sound data in a lower dimension; a lossy representation of at least part of the sound data; a lossless representation of at least part of the sound data; a time ordered series of any of the above; any combination of the above; and so forth. In some examples, the sound data may be preprocessed to extract edges, and the preprocessed sound data may include information based on and/or related to the extracted edges. In some examples, the sound data may be preprocessed to extract sound features from the sound data.

In some embodiments, analyzing sound data (for example, by the methods, steps and processor function described herein) may include analyzing the sound data and/or the preprocessed sound data using one or more rules, functions, procedures, artificial neural networks, object detection algorithms, anatomical detection algorithms, visual event detection algorithms, action detection algorithms, motion detection algorithms, background subtraction algorithms, inference models, and so forth. Some non-limiting examples of such inference models may include: an inference model preprogrammed manually; a classification model; a regression model; a result of training algorithms, such as machine learning algorithms and/or deep learning algorithms, on training examples, where the training examples may include examples of data instances, and in some cases, a data instance may be labeled with a corresponding desired label and/or result; and so forth.

In some embodiments, detection system 140 may train the machine learning or artificial intelligence model itself (e.g., locally, based on its environment 100). In other embodiments, detection system 140 may receive a trained version of the machine learning or artificial intelligence model from an external source (e.g., a network-connected server). In further embodiments, detection system 140 may provide data to such an external source (e.g., sound data collected at environment 100) to train a machine learning or artificial intelligence model.

The training of the machine learning or artificial intelligence model may be done in several ways, consistent with the above discussion of training techniques. For example, using the types of sensors discussed above, an acoustic signal may be measured and, in some embodiments, undergo processing, before being passed on for classification by a trained machine learning algorithm. By combining the processed signal with environmental (e.g., factory, office, laboratory, etc.) characteristic features (e.g., based on a unique physical, factory environment, such as environment 100), the machine learning algorithm may recognize leakage signatures more effectively. With each cycle of detection and classification the trained machine learning algorithm may improve its accuracy and sensitivity to leakage detection.

Some embodiments of the present disclosure relate to computer-implemented methods for training a machine learning algorithm to detect leaks of fluids. The disclosed techniques may comprise identification of a first dataset comprising first noise data and one or more first parameters associated with a fluid contained within a conduit structure. The parameters associated with the fluid contained within the conduit structure may include a diameter of the conduit structure, a pressure or temperature of the fluid within the conduit structure, a type of the fluid within the conduit structure, a type of the conduit structure itself, or any combination thereof (including, in some embodiments, all parameters together). In addition, other first parameters may include humidity, ambient noise associated with the conduit structure, time or date, geographic location, elevation, etc.

The first data set may be input to a machine learning algorithm, which may be configured to classify the first dataset. The non-exhaustive list of available classifications may include a leak of a fluid or a non-leak of the fluid. Other classifications may include a pressure excess state, a pressure loss state, a temperature excess state, a temperature loss state, a type of a leak, a size of a leak, a volume of fluid being lost, etc. In some embodiments, the machine learning algorithm may be trained on a regression task, so that it may provide estimates of physical quantities associated with a leak of fluid, such as size or severity of the leak.

Following classification of the first dataset, a second dataset comprising second noise data and one or more second parameters associated with the fluid may be identified. This second data set may be input to the machine learning algorithm for the algorithm to also classify the second dataset. Based on the second dataset, the machine learning algorithm may be updated, as this dataset may comprise data signatures absent in the first dataset. Thus, the machine learning algorithm may be trained and improved.

In one example, a machine learning algorithm may receive a first data set (e.g., acoustic data) for analysis and classification. The algorithm may be provided with a set of parameters such as a diameter of a pipe carrying a fluid, a pressure of the fluid carried by the pipe, and a type of fluid the pipe is carrying, as well as other parameters in some embodiments (e.g., temperature and humidity associated with the pipe, etc.). Based on the provided parameters the algorithm may analyze the dataset to classify the data as indicative of an absence of a fluid leak. The machine learning algorithm may then receive a second dataset from a different pipe, with a second set of parameters associated with this dataset. In this case the algorithm may detect new features in this data set and classify it as indicative of a fluid leak. The algorithm then may be updated and improved based on the new information contained in the second dataset.

In some embodiments, multiple leak sources in environment 100 may be simultaneously or separately identified by detection system 140. For example, in some situations both conduit 110 and conduit 120 may experience a leak. The two leaks may have different acoustic profiles, based on differences in conduits 110 and 120 (e.g., differences in fluid types, pressures, temperatures, leak sizes or shapes, and the like). In such embodiments, using one or more acoustic sensor, detection system 140 may detect both leaks (or more than two leaks) simultaneously. For example, in some embodiments as discussed further below, beamforming techniques may be used to locate the position of leaks. Such beamforming techniques may utilize fixed or switched beam techniques, adaptive beamforming, or the like, to focus microphones (e.g., arrays) in a particular physical location of environment 100 (e.g., conduits 110/120 or portions thereof). Other localization techniques may be implemented through triangulation or spatial sound intensity degradation and reflection analysis, among other techniques.

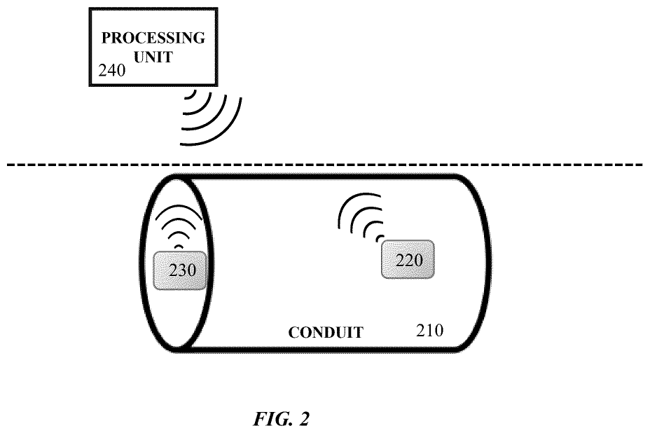

FIG. 2 illustrates an example conduit system for leakage detection, consistent with the disclosed embodiments. As illustrated, conduit 210 may include one or more sensors 220, 230 in communication with processing unit 240. For example, sensors 220, 230 may be integrated into (e.g., fastened to, adhered to, or otherwise affixed to an inner or outer surface of conduit 210. Alternatively, sensors 220, 230 may be configured to travel (e.g., robotically) throughout conduit 210 using locomotive techniques such as wheels, suction, treads, rotors, etc. In further embodiments, sensors 220, 230 may be located in a surrounding area outside of conduit 210.

As discussed above, conduit 210 may carry various types of fluids (e.g., liquid, gas, etc.) and may be composed of various types of materials. Sensors 220, 230 may take the form of acoustic sensors, light sensors, motion sensors, or any of the other types of various sensors discussed above. According to the discussion above, processing unit 240 may include an integrated machine learning or artificial intelligence model, or may receive data or instructions from a separate device (e.g., a network-connected server) running such a model. An input to the machine learning or artificial intelligence model of processing unit 240 may be data from sensors 220, 230, as discussed above.

In some embodiments, sensors 220, 230 may be powered locally (e.g., via batteries, a local power supply, or the like). In other embodiments, sensors 220, 230 may draw their power from their environment. For example, sensors 220, 230 may use techniques of kinetic energy harvesting to gather energy from physical movement (e.g., flow of a fluid in conduit 210), vibration, or heat, and convert the energy to electric energy (e.g., to be stored in a battery, capacitor, etc.). As an example, if conduit 210 is carrying flowing gas or liquid, sensors 220, 230 may draw their power from a turbine, which may be integrated into, or separate from, sensors 220, 230. As the turbine's rotor is turned by the flow of the gas or liquid, the turbine may generate electrical energy to power sensors 220, 230. Various other types of energy harvesting devices may be used in different embodiments. Further, in some embodiments sensors 220, 230 may be solar powered, wind powered, thermal gradient powered, or the like.

In accordance with FIG. 2, conduit 210 may be located in either a facility (e.g., manufacturing site, laboratory, factory, office, etc.) or in a remote location. For example, conduit 210 may be a natural gas pipeline spanning several feet or many miles. In such an embodiment, it may be advantageous for sensors 220, 230 to draw their power kinetically, as discussed above, so that they may operate without a dedicated (e.g., AC or DC) power supply. Further, in other embodiments conduit 210 may be located in a hard-to-reach location, such as in the ceiling of a building. Also in these embodiments, it may be advantageous for sensors 220, 230 to be self-powering, as discussed above. In some embodiments, sensors 220, 230 may come pre-installed (e.g., factory built) into conduit 210. Accordingly, the implementation of leakage detection techniques described herein may be accomplished without separately installing sensors 220, 230 after conduit 210 is installed. Alternatively, sensors 220, 230 may be installed (e.g., aftermarket) and integrated into conduit 210.

In some embodiments, sensors 220, 230 may communicate wirelessly with processing unit 240. For example, sensors 220, 230 may have onboard or separate communications interfaces such as WiFi™, Bluetooth™, infrared, radio frequency identification (RFID), cellular, satellite, or various others. Alternatively, sensors 220, 230 may communicate with processing unit 240 via a wired connection, such as ethernet, twisted pair, coaxial, or various others. In some such wired embodiments, sensors 220, 230 may receive their power via the wired connection (e.g., Power over Ethernet according to Institute of Electrical and Electronics Engineers (IEEE) 802.3af, 802.3at, or 802.3bt standards) or other power-over-line techniques. Similarly, in some embodiments processing unit 240 may receive its power via the wired connection.

Processing unit 240 may contain the functionality discussed above associated with detection system 140. Accordingly, processing unit 240 may implement pre-processing of raw sensor data (e.g., acoustic data). Further, processing unit 240 may include an onboard machine learning or artificial intelligence model, or may have access to a remotely hosted model. In embodiments where the machine learning or artificial intelligence model is separate from processing unit 240, processing unit 240 may communicate wirelessly (according to any of the above techniques) or via a wired connection with the machine (e.g., server) running the model. Accordingly, processing unit 240 may either perform machine learning and artificial intelligence locally at conduit 210 to detect leaks, or may provide sensor 220, 230 data remotely to a processing system for such detection.

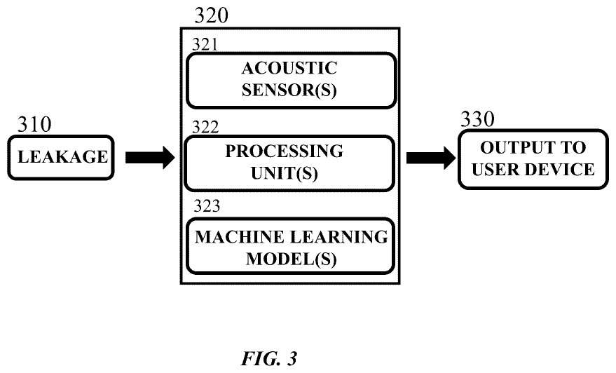

FIG. 3 illustrates an example system block diagram for acoustic leakage detection, consistent with the disclosed embodiments. As discussed above, conduits such as pipes 110, 120 and conduit 210 may experience leakages 310. The leakages 310 may arise from numerous conditions, such as excessive pressure of a fluid, a broken or faulty seal or sleeve, corrosion, cracks or holes, loose connections, open or defective faucets or nozzles, damaged joints, excessive heat or cold, and various other circumstances. In some embodiments, leakage 310 may represent not an actual leak itself, but instead the preconditions for a leak. For example, leakage 310 may represent conditions (e.g., an acoustic profile) of building pressure of a fluid, a breaking or deteriorating seal or sleeve, worsening corrosion, an expanding crack or hole, a loosening connection, an opening or breaking faucet or nozzle, a failing joint, increasing or decreasing temperatures, etc. Accordingly, actual leakages or the preconditions for such leakages may both represent leakage 310, and each may have a unique acoustic profile based on the machine learning and artificial intelligence techniques discussed above.

System 320 may comprise one or more acoustic sensors 321, one or more processing units 322, and one or more machine learning or artificial intelligence models 323, in accordance with the disclosure above. In some embodiments, system 320 may be a single computing device. For example, system 320 may be a computing device within a factory, laboratory, office, school, etc. In such embodiments, acoustic sensors 321 may be local to a conduit (e.g., pipes 110, 120 or conduit 210), while processing units 322 and machine learning models 323 may be local or remote from the conduit. Accordingly, processing units 322 and machine learning models 323 may be locally executed at system 320 or may be remotely executed. For example, either of processing units 322 and machine learning models 323 may be executed at a separate server or in the cloud. Such cloud-based embodiments may be based on virtual machines, container instances, serverless code, or the like (e.g., AWS™, AWS Lambda™, IBM Cloud™, Azure™, Docker™, Back4App™, Google Cloud Functions™, IBM Cloud Functions™, Microsoft Azure Functions™, etc.). In other embodiments, 320 may be multiple computing devices. For example, acoustic sensors 321, processing units 322, and machine learning models 323 may reside on two or more computing devices, either locally, remotely, or in the cloud.

As discussed above in connection with FIGS. 1 and 2, system 320 may receive acoustic data indicative of leakage 320 via acoustic sensors 321. System 320 may then compare the received acoustic data to data in machine learning models 323. Such comparisons may yield various types of outputs (e.g., exact matches or classifications, approximate matches or classifications, probabilities of matches or classifications, and the like. Based on such comparisons, as discussed above, system 320 may determine various conditions. For example, system 320 may determine an event of no leakage, a pre-leakage, an active leakage, etc. Further system 320 may determine a duration of a pre-leakage or active leakage, a size or shape of such leakage (e.g., a crack or deformation in a conduit), a volume of fluid lost due to the leakage, or various other conditions. Each of these conditions may be output 330 to a user device. For example, the output 330 may be a textual or graphical representation of a location in an environment of where a pre-leakage or leakage occurs, a textual or graphical representation of the size or shape of the leakage, a textual or graphical representation of the volume of fluid lost, etc. The output 330 may also express various other parameters of the environment in which leakage 310 is detected, such as time of day, date, temperature in the conduit, ambient temperature around the conduit, pressure in the conduit, pressure outside the conduit, a type of fluid in the conduit, a type or material of the conduit itself, a humidity inside the conduit, a humidity outside the conduit, etc. Further, in some embodiments the output 330 may express location information regarding equipment connected to the conduit. For example, if the conduit carries pressurized oxygen to a machine, the output 330 may indicate the machine (e.g., by machine name, type, location, serial number, etc.).

In different embodiments, output 330 may be presented or delivered in various ways. For example, output 330 may be presented on a graphical user interface (e.g., as a web page, Java™ content, or various other techniques). Further, output 330 may be delivered as a message, such as an email, text message, form submission, or the like. In further embodiments, output 330 may be an output message or signal sent to another system, such as a security information and event management (SIEM) system, a cybersecurity system, a physical security system, etc. Further, in some embodiments output 330's data is stored in a database (e.g., on-premises or in the cloud, consistent with above embodiments) for archiving, system monitoring, or auditing.

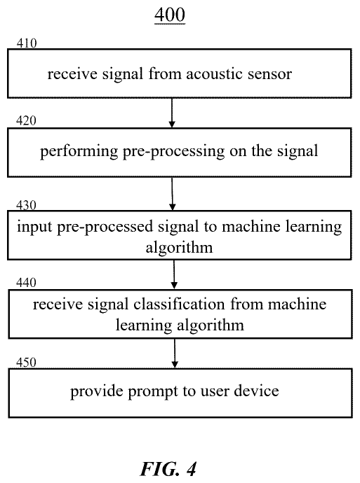

FIG. 4 illustrates an example process 400 for acoustic leakage detection, consistent with the disclosed embodiments. In some embodiments, process 400 may be carried out by detection system 140, processing unit 240, system 320, or other systems. Consistent with the discussion above, process 400 may obtain signals from a variety of different types of acoustic sensors. The acoustic sensors may be placed in an environment, such as environment 100, which may take a variety of different forms. In accordance with the discussion above, process 400 may be performed locally (e.g., within environment 100) or externally (e.g., via a separate server).

In process 400, step 410 may include receiving a signal from one or more acoustic sensor. The acoustic signal may be analog or digital in step 410. If needed, an analog signal may be converted to digital form (e.g., through quantization or sampling) for further processing. Further, the acoustic signal may have some degree of preprocessing already performed (e.g., filtering, gain control, augmentation, windowing, normalization, transformation, format conversion, etc.). Alternatively, the acoustic signal may have no preprocessing performed in step 410.

Process 400 may also include step 420, where preprocessing is performed on the signal. In some embodiments, the preprocessing includes analog-to-digital conversion. In other embodiments, the preprocessing may include filtering, gain control, augmentation, windowing, normalization, transformation, format conversion, or various other processing techniques.

Process 400 may further include step 430, where the preprocessed signal is input to a machine learning algorithm. For example, the machine learning algorithm may be implemented at detection system 140, processing unit 240, system 320, or a separate system, as discussed above. The machine learning algorithm may have been trained in accordance with above embodiments. For example, the machine learning algorithm may be trained according to sounds that are detected at a specific location (e.g., environment 100), by specific types of conduits, by specific types of machines (e.g., machines 131-136), or the like. In this way, the machine learning algorithm may be trained with a baseline of normal or expected noise in an environment. In some embodiments, normal or expected noise may include ambient noise, machine noise, human speech, doors opening and closing, fans operating, music playing, and various other types of noise not indicative of faults in conduits. Further, in some embodiments as discussed above the machine learning algorithm may be trained with specific acoustic data indicative of faults in conduits (e.g., excessive pressure of a fluid, a broken or faulty seal or sleeve, corrosion of conduits, cracks or holes in conduits, loose connections of conduits, open or defective faucets or nozzles, damaged joints of conduits, excessive heat or cold, and various other circumstances. In this way, as discussed above, the machine learning algorithm may be trained to differentiate (e.g., through comparisons), explicitly or indirectly, between normal or expected noise that is not indicative of a leak, and other noise that is indicative of a leak.

Process 400 may further include step 440, where a signal classification is received from the machine learning algorithm. In accordance with above embodiments, the signal may be received (or generated) at detection system 140, processing unit 240, system 320, or another system as discussed herein. As one example, the signal may indicate a no-fault circumstance. For example, this may indicate that signals received in step 410 align with normal or baseline noise, and are not indicative of a fault in a conduit. Alternatively, the signal may indicate a pre-fault circumstance. For example, this may indicate that the signal received in step 410 is indicative of pressure building in a conduit, a crack forming in a conduit, a nozzle or value deteriorating in a conduit, corrosion growing in a conduit, or the like. In further embodiments, the signal in step 440 may indicate that a fault condition exists. For example, this may involve confirming based on the machine learning algorithm that the signal received in step 410 is indicative of an active leak or other fault.

Process 400 may further include a step 450 of providing a prompt to a user device. For example, the prompt may be the output 330, as discussed above. In accordance with the above discussion, the prompt in step 405 may include a web page, Java™ display, email, text message, input to another monitoring or security system, or various other types of displays, prompts, or alerts. As discussed herein, the prompt may indicate a location of the leak (e.g., in a 2-D or 3-D map of a facility, coordinates, location at a particular conduit or machine, etc.), a type of the leak (e.g., breakage, crack, open valve, corrosion, etc.), a size of the leak (e.g., a measurement, a percentage, etc.), a shape of the leak (e.g., crack, hole, open valve, etc.), an identifier of a conduit associated with the leak, an identifier of a machine associated with the leak, a time the leak started, a duration of the leak, a root cause of the leak, or various other information associated with the leak.

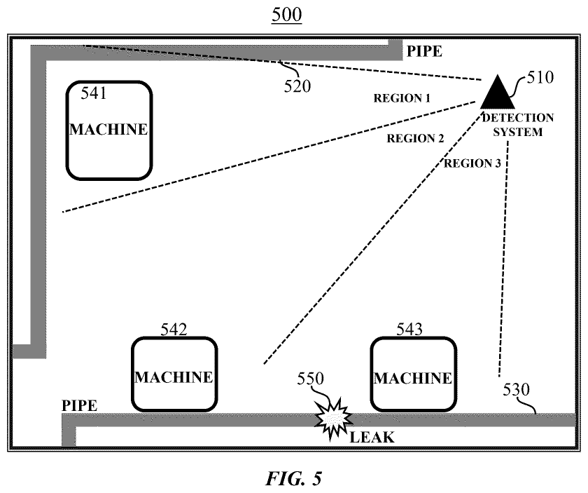

FIG. 5 illustrates an example environment 500 for leakage detection, consistent with the disclosed embodiments. Consistent with above embodiments, environment 500 may correspond to environment 100, detection system 510 may correspond to detection system 140, processing unit 240, or system 320, conduits 520/530 may correspond to conduits 110/120, conduit 210, machines 541-543 may correspond to machines 131-136, and leak 550 may correspond to leakage 310.

In accordance with FIG. 5, detection system 510 may be configured to perform one or more of training, validation, or detection of signals in environment 500. As illustrated, detection system 510 may have three (or more or less) regions for sensing conditions in environment 500. For example, detection system 510 may sense acoustic characteristics, electromagnetic characteristics, light characteristics, movement characteristics, or various other characteristics detectable by the various types of sensors discussed above.

As an example, detection system 510 may contain one or more microphones configured to monitor sounds from Region 1, Region 2, and Region 3. In some embodiments, the one or more microphones may be integrated into detection system 510 as a physical unit, whereas in other embodiments the one or more microphones may be separate from detection system 510 (e.g., located proximate to machines 541, 542, and 543. One exemplary technique for focusing the microphones on machines 541-543 in Regions 1-3 is through beamforming. A beamforming technique (e.g., performed by detection system 510) may utilize fixed or switched beam techniques, adaptive beamforming, or the like, in order to focus the microphones in a particular physical location of environment 500 (e.g., conduits 510/530 or portions thereof). Using beamforming techniques like these may provide the benefit of focusing the directivity of the microphones, isolating sounds of interest (e.g., leakages) and minimizing other sounds in environment 500 (e.g., machine operation, wind, human voice, etc.). Of course, beamforming need not be used in every embodiment, and microphones located proximate to conduits 520/530 may be able to capture sound in Regions 1-3 as well. Other location techniques may be implemented through triangulation or spatial sound intensity degradation and reflection analysis, among other techniques.

As discussed above, detection system 510 may be configured to perform training or validation of signals detected in environment 500. For example, detection system 150 may be configured to collect samples of acoustic data from environment 500 and, using the machine learning techniques discussed above, train a model to be able to distinguish between normal or baseline environment 500 noise, and leakage noise or other anomalous noise 550. In some embodiments, detection system 510 may be trained to use a common classification model to identify leakages in Regions 1-3. In other embodiments, where acoustic profiles of leakages in Regions 1-3 may differ, detection system 510 may be trained to uniquely identify leakages in each of Regions 1-3. For example, one specific classification may allow detection system 510 to determine that the leak is associated with conduit 520 or machine 541, while another specific classification may allow detection system 510 to determine that the leak is associated with conduit 530 or machine 543, etc. Further, as discussed herein, the machine learning model may be configured to determine other parameters associated with a leak such as leak 550, such as a location of the leak (e.g., in a 2-D or 3-D map of a facility, coordinates, location at a particular conduit or machine, etc.), a type of the leak (e.g., breakage, crack, open valve, corrosion, etc.), a size of the leak (e.g., a measurement, a percentage, etc.), a shape of the leak (e.g., crack, hole, open valve, etc.), an identifier of a conduit associated with the leak, an identifier of a machine associated with the leak, a time the leak started, a duration of the leak, a root cause of the leak, or various other information associated with the leak.

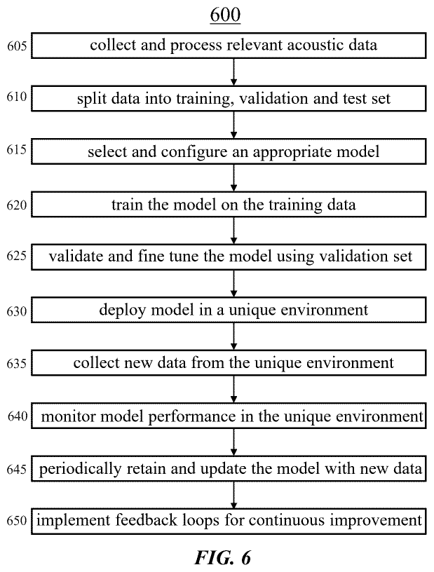

FIG. 6 illustrates an example process 600 for training a machine learning model to classify acoustic data, consistent with the disclosed embodiments. In some embodiments, process 600 may be carried out by detection system 140, processing unit 240, system 320, detection system 510, or other systems. Consistent with the discussion above, process 600 may obtain signals from a variety of different types of acoustic sensors. The acoustic sensors may be placed in an environment, such as environments 100 or 500, which may take a variety of different forms. In accordance with the discussion above, process 600 may be performed locally (e.g., within environment 100) or externally (e.g., via a separate server).

Process 600 may include a step 605 of collecting and processing relevant acoustic data. For example, as discussed above with regard to environment 500, microphones may capture acoustic signals associated with Regions 1-3. Through techniques such as beamforming, the microphones may focus their directivity on each of Regions 1-3, or specific parts thereof (e.g., on conduits 520/530, or portions thereof). Alternatively, beamforming need not be used, and instead microphones may be located proximate to the sound sources being monitored or alternatively triangulation, intensity degradation analysis, or sound reflection analysis may be conducted to point to or identify the location of leakages.

Process 600 may also include a step 610 of splitting data into training, validation, and test data sets. For example, as discussed above, a machine learning system (e.g., implemented at detection system 510 or separate) may train machine learning algorithms using validation examples and/or test examples. As discussed above, validation examples and/or test examples may include example inputs (e.g., acoustic data associated with ambient, background, or expected noise, or associated with leakage noise profiles) together with the desired outputs (e.g., no fault condition, or fault condition) corresponding to the example inputs. A trained machine learning algorithm and/or an intermediately trained machine learning algorithm may be used to estimate outputs (e.g., no fault condition, or fault condition) for the example inputs of the validation examples and/or test examples. The estimated outputs may be compared to the corresponding desired outputs, and the trained machine learning algorithm and/or the intermediately trained machine learning algorithm may be evaluated based on a result of the comparison. The result, as discussed above, may be an exact match or classification, and approximate match or classification, a probability of a match or classification, or the like. In some embodiments, the machine learning algorithm may have parameters and hyper-parameters, where the hyperparameters may be set manually by a person or automatically by a process external to the machine learning algorithm (such as a hyper-parameter search algorithm), and the parameters of the machine learning algorithm may be set by the machine learning algorithm according to the training examples. In some implementations, the hyper-parameters may be set according to the training examples and the validation examples, and the parameters may be set according to the training examples and the selected hyper-parameters.

Process 600 may also include a step 615 of selecting and configuring the appropriate model. For example, in some embodiments, the machine learning model may be configured for environment 500 as a whole. In other embodiments, the machine learning model may be configured uniquely for each of Regions 1-3, or portions thereof. Further, the model may be configured as needed to perform the training. Examples of parameters that may be configured include time of day, day of week, type of machines 541-543, types of conduits 520-530, lengths of conduits 520/530, diameters of conduits 520/530, materials of conduits 520-530, pressure in environment 500, pressure of a fluid in conduits 520-530, temperature in environment 500, temperature in conduits 520-530, fluid type in conduits 520-530, duration of a fluid flowing in conduits 520-530, usage rates of a fluid flowing in conduits 520-530, dates of last maintenance or repair of conduits 520-530, etc.

Process 600 may also include a step 620 of training the machine learning model using the training data. For example, as discussed above, the machine learning model may be trained to classify or distinguish between normal or no-fault conditions (e.g., machine operation, human voice, wind, etc.) and anomaly or fault conditions (e.g., leaks). In some embodiments, training data from one training environment may be used in another operational environment, while in other embodiments the training data comes from the operational environment (e.g., environment 500) itself.

Process 600 may further include a step 625 of validating and fine tuning the machine learning model using the validation set. For example, as discussed above, the machine learning algorithm may further use validation examples and/or test examples to classify or distinguish between fault and no-fault conditions in environment 500. The validation examples and/or test examples may include example acoustic data (e.g., representing fault or no-fault conditions in Regions 1-3) together with the desired outputs (e.g., classifications of fault or no-fault, types of leaks, sizes of leaks, etc.) corresponding to the example inputs. The trained machine learning algorithm and/or an intermediately trained machine learning algorithm may be used to estimate outputs for the example inputs of the validation examples and/or test examples. Further, as discussed above, the estimated outputs may be compared to the corresponding desired outputs, and the trained machine learning algorithm and/or the intermediately trained machine learning algorithm may be evaluated based on a result of the comparison. Any of the validation and adjustment techniques described above may be used to more accurately classify or distinguish between particular sounds or sound profiles.

Process 600 may further include a step 630 of deploying the machine learning model in a unique environment. The environment may be any of the various types of environments discussed above, such as environment 100 or environment 500. The machine learning model may be deployed in several ways. For example, if the machine learning model is locally trained and developed (e.g., at detection system 140, processing unit 240, or system 320), it may be changed in mode from a training mode to an operational mode. Further, in embodiments where the machine learning model is developed external to detection system 140, processing unit 240, or system 320, it may be transmitted (e.g., wirelessly, via a wired connection, etc.) to detection system 140, processing unit 240, or system 320. Alternatively, in embodiments where the machine learning model is executed separate from detection system 140, processing unit 240, or system 320, it may be provided to a computing device that will then execute it for use in environments such as environment 100 and environment 500.

Process 600 may further include a step 635 of collecting new data from the unique environment. As discussed above, this collection may include utilizing sensors deployed in environments 100 and 500, such as microphones (e.g., micro-electro-mechanical system (MEMS), condenser, electret condenser, dynamic, ribbon, etc.). In alternate embodiments where process 600 is used to collect, test, and analyze non-acoustic data, other types of sensors may be used in step 635 (e.g., light-based sensors (e.g., photosensors), electromagnetic sensors, induction coils, hall sensors, giant magnetoresistance (GMR) sensors, anisotropic magnetoresistance (AMR) sensors, pressure sensors, ultrasound sensors, humidity sensors, accelerometers, gyroscopes, flex sensors, color sensors, smoke sensors, and various others). In accordance with the above discussion, step 635 may involve preprocessing the collected data, or may omit such a preprocessing step.

Process 600 may further include a step 640 may include monitoring the performance of the machine learning model in the unique environment. This monitoring may include ascertaining how accurately the machine learning model classifies or differentiates between ambient or default noise (e.g., machine noise, wind, human voice, etc.) and fault-indicative noise (e.g., a leak in a conduit). In some embodiments, the performance may be expressed as a numerical score (e.g., 1-10, 1-100, etc.), as a percentage, or the like. The performance level may be used to further train the machine learning model. For example, if the performance level is determined to be below a threshold success in classifying particular noises, a determination may be made to continue the training process (e.g., collect more samples, validate more results, etc.). Alternatively, if the performance level is above a threshold, a determination may be made that additional training is not needed.

Process 600 may further include a step 645 of periodically retaining and updating the model with new data. For example, according to set periods of time or other events, the machine learning model may be updated with new data. This may involve continually training the machine learning model with additional data (e.g., acoustic data) regarding a particular type of leak, additional data regarding new types of environments, or various other new data in environments 100 and 500. In some embodiments, various different models may be created and retained for a particular environment (e.g., focusing on different areas in the environment).

Process 600 may further include a step 650 of implementing feedback loops for continuous improvement of the machine learning model. For example, the feedback loops may be configured, as discussed above, to continuously or periodically train the machine learning model with new training data and/or new real world data. In this way, the machine learning model may be able to continually improve its accuracy in classifying particular sounds in environments 100 and 500, and differentiating between fault and no-fault conditions (e.g., between ambient noise and leaks).

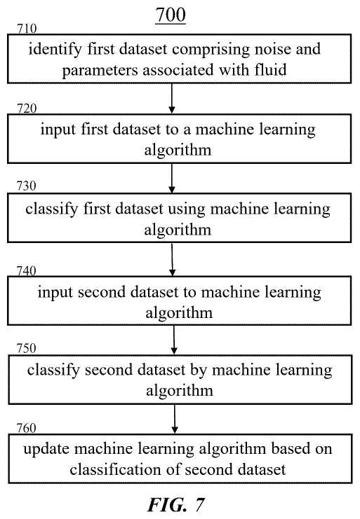

FIG. 7 illustrates an example process 700 for updating a machine learning model, consistent with the disclosed embodiments. In some embodiments, process 700 may be carried out by detection system 140, processing unit 240, system 320, detection system 510, or other systems. Consistent with the discussion above, process 700 may obtain signals from a variety of different types of acoustic sensors. The acoustic sensors may be placed in an environment, such as environments 100 or 500, which may take a variety of different forms. In accordance with the discussion above, process 700 may be performed locally (e.g., within environment 100) or externally (e.g., via a separate server).

Process 700 may include a step 710 of identifying a first dataset comprising noise and parameters associated with a fluid. For example, the first dataset may include acoustic data based on sounds of a fluid moving in a conduit. The sounds may be based on the fluid moving without leakage, with leakage, or both. As discussed above, the parameters may include various characteristics such as a diameter of the conduit structure, a pressure or temperature of the fluid within the conduit structure, a type of the fluid within the conduit structure, a type of the conduit structure itself, humidity, ambient noise associated with the conduit structure, time or date, geographic location, elevation, etc. Various other parameters may be included as well.

Process 700 may further include a step 720 of inputting the first dataset to a machine learning algorithm. As discussed above, the machine learning model may take various forms of algorithms, such as classification algorithms, data regressions algorithms, acoustic segmentation algorithms, acoustic detection algorithms, auditory recognition algorithms, speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. The machine learning algorithm may further be trained according to the various training techniques discussed above.

Process 700 may further include a step 730 of classifying the first dataset using the machine learning algorithm. In some embodiments, this may include assigning a classification such as fault or no-fault (e.g., leak or no leak), a precondition for a leak (e.g., building pressure, temperature, corrosion, etc.), a size of a leak, a type of a leak, or various other characteristics.

Process 700 may also include a step 740 of inputting a second dataset to the machine learning algorithm. The machine learning model, consistent with the above disclosure, may take various forms of algorithms, such as classification algorithms, data regressions algorithms, acoustic segmentation algorithms, acoustic detection algorithms, auditory recognition algorithms, speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. The machine learning algorithm may further be trained according to the various training techniques discussed above.

Process 700 may also include a step 750 of classifying the second dataset by the machine learning algorithm. Consistent with the discussion above, this may include assigning a classification such as fault or no-fault (e.g., leak or no leak), a precondition for a leak (e.g., building pressure, temperature, corrosion, etc.), a size of a leak, a type of a leak, or various other characteristics. In some embodiments, the second dataset may relate to the first dataset. For example, both may pertain to the same conduit, same leak, same environment, etc. In such embodiments, both may be useful in incrementally training the machine learning model based on differing instances (e.g., differing times) of collection of the data in the dataset. Because such data may change somewhat over time, but still be indicative of the same occurrence (e.g., same ambient noise, same leakage, etc.), both may be useful in training the machine learning model and improving its accuracy. In other embodiments, the first and second datasets may be distinct from each other.

Process 700 may further include a step 760 of updating the machine learning algorithm based on a classification of the second dataset. For example, as discussed above, the machine learning algorithm may be updated based on a classification such as fault or no-fault (e.g., leak or no leak), a precondition for a leak (e.g., building pressure, temperature, corrosion, etc.), a size of a leak, a type of a leak, or various other characteristics. Of course, process 700 may be repeated with additional datasets too, and step 760 may be continually or periodically performed to continue the training process and improve the accuracy of the machine learning model.

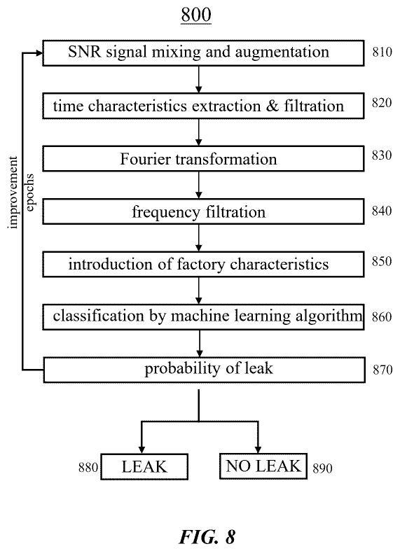

FIG. 8 illustrates an example process 800 for fluid leakage classification, consistent with the disclosed embodiments. In some embodiments, process 800 may be carried out by detection system 140, processing unit 240, system 320, detection system 510, or other systems. Consistent with the discussion above, process 800 may obtain signals from a variety of different types of acoustic sensors. The acoustic sensors may be placed in an environment, such as environments 100 or 500, which may take a variety of different forms. In accordance with the discussion above, process 800 may be performed locally (e.g., within environment 100) or externally (e.g., via a separate server).

Process 800 may include a step 810 of performing signal-to-noise (SNR) signal mixing or augmentation of a received signal. For example, as discussed above, various types of processing may be performed on collected signals (e.g., audio signals). Examples include filtering, gain control, augmentation, windowing, normalization, transformation, format conversion, representing at least part of the sound data in a frequency domain, performing a Discrete Fourier Transform of at least part of the sound data, performing a Discrete Wavelet Transform of at least part of the sound data, creating a time/frequency representation of at least part of the sound data, creating a representation of at least part of the sound data in a lower dimension, creating a lossy representation of at least part of the sound data, creating a lossless representation of at least part of the sound data, creating a time ordered series of any of the above, etc. Among these various types of processing, as discussed above, step 810 may include SNR signal mixing and augmentation, step 820 may include time characteristic extraction and filtration, step 830 may include a Fourier transformation, step 840 may include a frequency filtration (e.g., high pass, low pass, or band pass, etc.), step 850 may include introduction of factory characteristics (e.g., attributes of environment 100 or 500, as discussed above), and step 860 may include classification by a machine learning algorithm (e.g., in terms of fault, no fault, a precondition for a fault, etc.). Process 800 may further include calculating a probability of having a leak in step 870. For example, the probability in step 870 may be based on the machine learning or artificial intelligence techniques discussed above, and may yield a probability score, percentage, or the like. The process of classifying the received and processed signals in this way in step 860 and generating a probability in step 870 may be periodically or continuously repeated, as illustrated in FIG. 8. In this manner, the machine learning model may be improved over time to enhance its accuracy in making classifications and differentiations.

Based on the classifications in step 860 and/or probabilities in step 870, process 800 may further include making a determination based on the classification and/or probability. For example, if the classification or probability indicates a leak (or a likelihood above a threshold of a leak), a determination may be made in step 880 about actions to take. As discussed above in connection with FIG. 3 and operation 330, various types of outputs may be generated, communicated, or displayed based on the detection of a leak. Alternatively, if the classification is one of a non-leak, a determination may be made in step 890 about appropriate actions to take (or not take). For example, process 800 may in step 890 take no action and instead repeat steps 810-870. Alternatively, an output, such as output 330, may indicate a normal, baseline, or ambient sound profile for an environment 100 or 500.

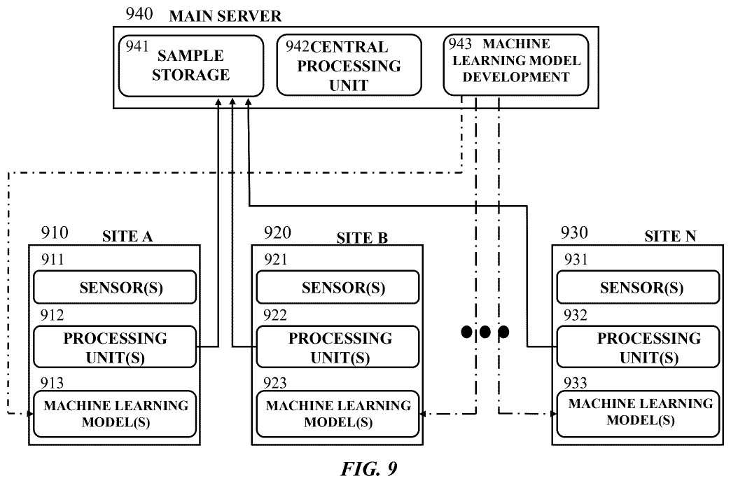

FIG. 9 illustrates an example centralized system environment for leakage detection, consistent with the disclosed embodiments. In some embodiments, the system of FIG. 9 may be implemented in environments 100 or 500. For example, main server 940 (or any of its components 941, 942, 943) may be implemented by detection system 140, processing unit 240, system 320, or detection system 510. Further, Site A 910 may correspond to environment 100 or 500, Site B 920 may correspond to the same or different environments, and various other sites, through Site N 930, may correspond to the same or different environments. Each site 910-930 may include one or more sensors 911, 921, 931, processing units 912, 922, 932, and machine learning models 913, 923, 933, as discussed above in various embodiments.

The system of FIG. 9 may be operated to centrally create, train, or update machine learning models via machine learning model development 943. This process may be carried out by central processing unit 942, which may be a microprocessor, embedded processor, or the like, or may be integrated in a system on a chip (SoC). According to some embodiments, central processing unit 942 may be from the family of processors manufactured by Intel®, AMD®, Qualcomm®, Apple®, NVIDIA®, or the like. Central processing unit 942 may also be based on the ARM architecture, a mobile processor, or a graphics processing unit, etc. The disclosed embodiments are not limited to any type of processor configured as central processing unit 942. The raw data, training data, and/or algorithms used in the machine learning model development 943 may be stored in sample storage 941.

In some embodiments, a machine learning model may be developed at machine learning model development 943 according to the various techniques above. From this centralized location at main server 940, the model may be deployed to various sites, such as Sites A-N 910-930. In this way, each of Sites A-N 910-930 may run the same machine learning model locally at their environment. Alternatively, machine learning model development 943 may uniquely develop different machine learning models for each of Sites A-N 910-930. In such embodiments, machine learning model development 943 may gather raw data and/or training data from Sites A-N 910-930, and may develop and train a machine learning model customized for each of Sites A-N 910-930. As an example, Site A 910 may be a manufacturing facility, Site 920 B may be a processing plant, and Site N 930 may be an laboratory. In such embodiments, the types of machines, conduits, and leaks at each of Sites A-N 910-930 may differ based on the unique operations at each site. Accordingly, machine learning model development 943 may develop or train a machine learning model unique to each of Sites A-N 910-930 based on the types of acoustic signals detected at each site, using the machine learning techniques above.

Each of Sites A-N 910-930 may provide raw or training data to main server 940 periodically, continuously, or on an ad hoc basis. For example, during a training phase, Sites A-N 910-930 may send their training data to main server 940 for training machine learning models in storage 941. Upon deployment of the models at Sites A-N 910-930, the models may be trained further, or may be left in an operational state without further training.

In some embodiments, it may be determined to use a particular machine learning model developed at main server 940 for two or more different sites. For example, main server 940 may store data pertaining to Site A 910, such as a type of pipe being used to carry a particular gas at a specific pressure. If main server 940 determines that Site B 920 also uses this type of pipe to carry the same gas at the same pressure, main server 940 may determine that the machine learning model used for Site A 910 should also be deployed to Site B 920. Accordingly, main server 940 may transmit the trained model for used for Site A 910 to Site B 920. In this manner, main server 940 may avoid the unnecessary work of developing or training a new model for Site B 920 anew.

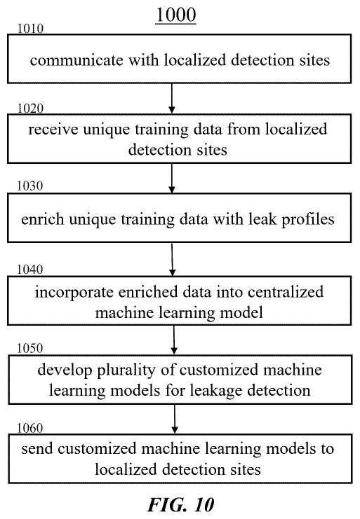

FIG. 10 illustrates an example process 1000 for centralized leakage detection model development, consistent with the disclosed embodiments. In some embodiments, process 1000 may be carried out by detection system 140, processing unit 240, system 320, detection system 510, main server 940, or other systems. Consistent with the discussion above, process 1000 may obtain signals from a variety of different types of acoustic sensors. The acoustic sensors may be placed in an environment, such as environments 100 or 500, which may take a variety of different forms. In accordance with the discussion above, process 1000 may be performed locally (e.g., within environment 100) or externally (e.g., via a separate server).

Process 1000 may include a step 1010 of communicating with localized detection sites. For example, the communication may happen in several ways. The communication may involve main server 940 communicating a machine learning model from machine learning model development 943, or updates thereto, to Sites A-N 910-930. Further, the communication may include Sites A-N 910-930 communicating raw or training data (e.g., sound data) collected by sensors 911, 921, 931 to main server 940. In accordance with above embodiments, the communications may be wireless, wired, or otherwise. Further, the communications may be continuous, periodic, or ad hoc in timing.

Process 1000 may also include a step 1020 of receiving unique training data from localized detection sites. In accordance with above embodiments, the unique training data may be sound data (or various other types of data) gathered using sensors 911, 921, 931 at Sites A-N 910-930.

Process 1000 may further include a step 1030 of enriching the unique training data with leak profiles. For example, this may include adding acoustic profiles of particular types of leaks (e.g., due to excessive pressure of a fluid, a broken or faulty seal or sleeve, corrosion, cracks or holes, loose connections, open or defective faucets or nozzles, damaged joints, excessive heat or cold, and various other circumstances). Further, in some embodiments the acoustic profiles may represent not an actual leak itself, but instead the preconditions for a leak. For example, the acoustic profiles may represent sounds of building pressure of a fluid, a breaking or deteriorating seal or sleeve, worsening corrosion, an expanding crack or hole, a loosening connection, an opening or breaking faucet or nozzle, a failing joint, increasing or decreasing temperatures, etc. In accordance with FIG. 9, for example, the acoustic profiles may be stored in sample storage 941.

Process 1000 may also include a step 1040 of incorporating the enriched data into a centralized machine learning model. For example, in FIG. 9 the enriched data may be transmitted from sample storage 941 to machine learning model development 943, and used in the machine learning model training.

Process 1000 may further include a step 1050 of developing a plurality of customized machine learning models for leakage detection. As discussed above, main server 940 may develop a single machine learning model for all of Sites A-N 910-930, or may develop customized models for each site. Further, within a given Site A-N 910-930, multiple different machine learning models may potentially be deployed. For example, one model may be developed and deployed for one physical space in a building while another model may be developed and deployed for a separate space in the building

Process 1000 may also include a step 1060 of sending customized machine learning models to localized detection sites. As discussed above, this may include main server 940 transmitting the trained machine learning models to Sites A-N 910-930. The transmission may be wireless, wired, etc. The customized models may then be executed locally at each of Sites A-N 910-930.

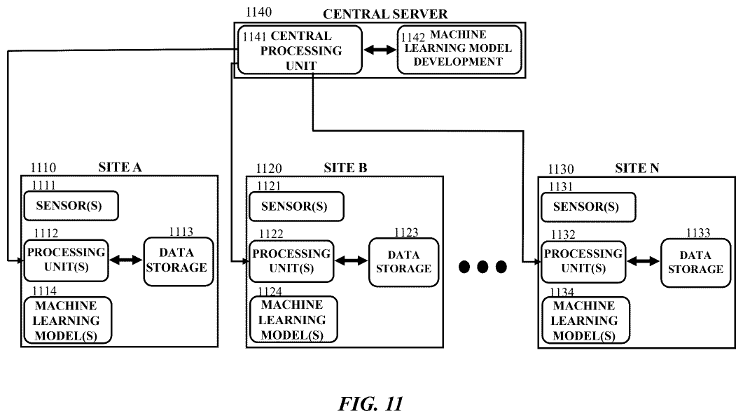

FIG. 11 illustrates an example decentralized system environment for leakage detection, consistent with the disclosed embodiments. In many respects, the system of FIG. 11 may be similar to the system of FIG. 9. For example, central server 1140 may correspond to main server 940, central processing unit 1141 may correspond to central processing unit 942, machine learning model development 1142 may correspond to machine learning model development 943, Sites A-N 1110, 1120, 1130 may correspond to Sites A-N 910, 920, 930, sensors 1111, 1121, 1131 may correspond to sensors 911, 921, 931, processing units 1112, 1122, 1132 may correspond to processing units 912, 922, 932, and machine learning models 1114, 1124, 1134 may correspond to machine learning models 913, 923, 933.

In contrast to the system of FIG. 9, however, the system of FIG. 11 may allow Sites A-N 1110, 1120, 1130 to train their own machine learning models 1114, 1124, 1134 locally. In particular, just as main server 940 can be configured to receive training data from particular environments and train its machine learning models for deployment, Sites A-N 1110-1130 may each locally train their own machine learning models. In accordance with above embodiments, Sites 1110-1130 may each locally receive raw or training data via sensors 111, 1121, 1131 to train their machine learning models 1114, 1124, 1134, and they deploy those models operationally to detect leaks or other fault conditions in Sites A-N 1110-1130.

One of the benefits of the architecture of FIG. 11 is that Sites A-N 1110-1130 may potentially operate machine learning models 1114, 1124, 1134 stored locally at their sites without a network connection. For example, some examples of Sites A-N 1110-1130 may include environments that are far from network communications, that are in WiFi or other wireless communications dead spots, that involve machinery or materials that could damage communication equipment, or are otherwise unable to communicate reliably with outside networks. In these embodiments, if central server 1140 centrally develops and provides default machine learning models to Sites A-N 1110-1130, which they can then train and deploy, Sites A-N 1110-1130 may be able to successfully monitor for faults at their local environments without requiring an ongoing network connection. This may improve fault detection in various types of challenging environments.

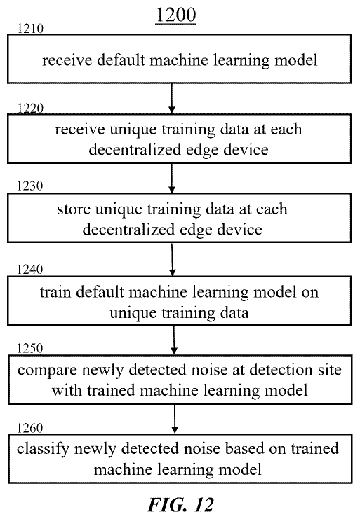

FIG. 12 illustrates an example process 1200 for decentralized leakage detection model development, consistent with the disclosed embodiments. In some embodiments, process 1200 may be carried out by detection system 140, processing unit 240, system 320, detection system 510, processing units 912, 922, 932, processing units 1112, 1122, 1132, or other systems. Consistent with the discussion above, process 1200 may obtain signals from a variety of different types of acoustic sensors, such as sensors 911, 921, 931 or sensors 1111, 1121, 1131. The acoustic sensors may be placed in an environment, such as environments 100 or 500, which may take a variety of different forms. In accordance with the discussion above, process 1200 may be performed locally (e.g., within environment 100 or 500) or externally (e.g., via a separate server).

Process 1200 may include a step 1210 of receiving a default machine learning model. As discussed above, the machine learning model may be provided by central server 1140 to Sites A-N 1110-1130, may come preinstalled on data storage 1113, 1123, 1133, or may otherwise be transmitted to Sites A-N 1110-1130. In some embodiments, the machine learning model may be untrained. In that case, the model may be trained according to the above techniques locally at Sites A-N 1110-1130. Alternatively, the machine learning model may contain partial or complete training. For example, the model may be partially or fully trained at machine learning model development 1142 before being sent to Sites A-N 1110-1130.

Process 1200 may also include a step 1220 of receiving unique training data at each decentralized edge device. As discussed above, the training data may be unique to each of Sites A-N 1110-1130. For example, the training data may have been gathered using sensors 1111, 1121, 1131 in Sites A-N 1110-1130. Alternatively, in some embodiments the training data may be provided from a separate system (e.g., a repository of training data).

Process 1200 may further include a step 1230 of storing unique training data at each decentralized edge device. In accordance with above embodiments, the decentralized edge devices may be located at Sites A-N 1110-1130. The training data may be stored, for example, in data storage 1113, 1123, 1133.

Process 1200 may also include a step 1240 of training default machine learning model on unique training data. As discussed above, various techniques may be used to train each machine learning model 1113, 1124, 1134 at sites Sites A-N 1110-1130.

Process 1200 may further include a step 1250 of comparing newly detected noise at detection site with trained machine learning model. Consistent with above embodiments, the newly detected noise at Sites A-N 1110-1130 may be gathered by sensors 1111, 1121, 1131. This data may be stored in data storage 1113, 1123, 1133 and may be compared with data in the trained machine learning models 1114, 1124, 1134.

Process 1200 may also include a step 1260 of classifying newly detected noise. As discussed above, the newly detected noise data may be classified, according to machine learning models 1114, 1124, 1134 (e.g., as a leak or non-leak, or probability of a leak, etc.). The classification may be exact, approximate, a probability, or the like. In that event, various responsive actions may be taken, as discussed above for example in connection with operation 330 of FIG. 3 and step 870 of FIG. 8.

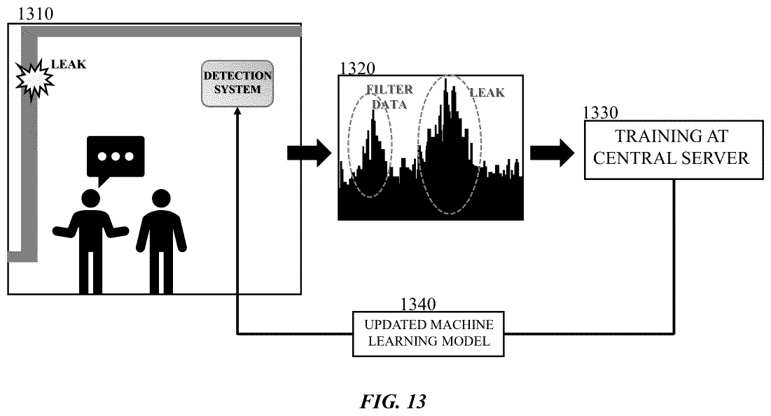

FIG. 13 illustrates an example system environment for data privacy and leakage detection, consistent with the disclosed embodiments. In some embodiments, the system of FIG. 13 may be implemented in environments 100 or 500, or in connection with other systems described above. For example, the training at central server 1330 may be implemented by detection system 140, processing unit 240, system 320, or detection system 510. Alternatively, the training at central server 1330 may be performed at main server 940 of FIG. 9 or central server 1140 of FIG. 11.

In accordance with FIG. 13, the detection system as illustrated may correspond to detection system 140, processing unit 240, system 320, or detection system 510. The detection system may be configured to collect sound data, or other data in environment 1310, using one or more sensors. Some or all of the data collected by the detection system may be sent to update a machine learning model in operation 1340 or to train a model at a central server 1330. In some embodiments, before either or both of these transmissions of data, a filtering operation 1320 may be performed. For example, the filtering may be performed by detection system, or a separate system. The filtering may be done, at least in part, according to a filtering criterion.

In some embodiments, the filtering criterion may include a data privacy or personal privacy criterion. For example, in some embodiments it may be desirable to filter out frequency ranges associated with human voice, since the content of human speech may be subject to data privacy or personal privacy protections (e.g., the General Data Protection Regulation (GDPR), or various other protections). In such embodiments, human speech may be filtered out at operation 1320, leaving sound data in other frequency ranges for transmission to update a machine learning model in operation 1340 and/or training a model at operation 1330. Various other types of filtering are possible as well (e.g., filtering certain times of day, filtering times when human voice is detected, filtering typing or computing interaction sounds, filtering machine noise, etc.).

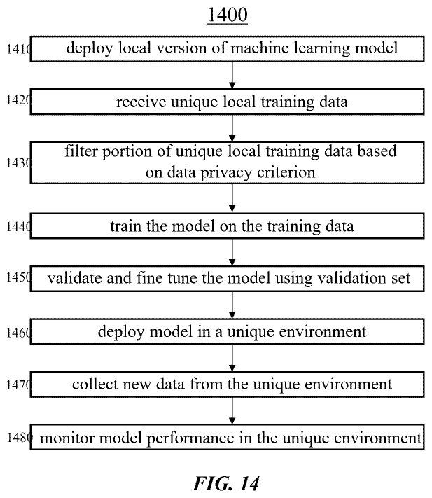

FIG. 14 illustrates an example process 1400 for data privacy and leakage detection, consistent with the disclosed embodiments. In some embodiments, process 1400 may be carried out by detection system 140, processing unit 240, system 320, detection system 510, processing units 912, 922, 932, processing units 1112, 1122, 1132, or other systems. Consistent with the discussion above, process 1400 may obtain signals from a variety of different types of acoustic sensors, such as sensors 911, 921, 931 or sensors 1111, 1121, 1131. The acoustic sensors may be placed in an environment, such as environments 100 or 500, which may take a variety of different forms. In accordance with the discussion above, process 1400 may be performed locally (e.g., within environment 100 or 500) or externally (e.g., via a separate server).

Process 1400 may include a step 1410 of deploying local version of machine learning model. For example, in accordance with FIG. 13 this may include deploying a trained machine learning model at environment 1310. The model may be fully trained, partially trained, or the like. The model may be provided wirelessly, over a wired connection, or through other techniques as discussed above.

Process 1400 may further include a step 1420 of receiving unique local training data. The training data, in accordance with above embodiments, may allow for the model to be customized for the environment 1310. For example, the model may be able to detect a particular type of leak, as shown in FIG. 13.

Process 1400 may also include a step 1430 of filtering portion of unique local training data based on data privacy criterion. As discussed above, the data privacy criterion may include a frequency range associated with human voice. Alternatively, the data privacy criterion may include a time of day, a time human voice is detected, typing or computing interaction sounds, machine noise, etc. Some or all data satisfying the data privacy criterion may be filtered out of the signal, thus leaving the remainder of the signal. This remaining signal may include, for example, sound data corresponding to a detected leak in environment 1310.

Process 1400 may further include a step 1440 of training the model on the training data. With the specific data filtered in step 1430, step 1440 may thus allow remaining data (e.g., sound data) to be transmitted to update a machine learning model in operation 1340 or train a model at a central server in operation 1330.

Process 1400 may also include a step 1450 of validating and fine tune the model using validation set. As discussed above, the model may be validated and fine tuned according to various techniques.

Process 1400 may further include a step 1460 of deploying model in a unique environment. This deployment may be done wirelessly, over a wired connection, etc. In accordance with process 1400, however, the deployed model may lack any filtered data, such as human voice data that was filtered out in operation 1320.

Process 1400 may also include a step 1470 of collecting new data from the unique environment. Thus, according to above embodiments, during operation of the system new sound data may be captured in environment 1310 by sensors. Consistent with the above discussion, some of this new data may be filtered in operation 1320 as well, or it may be unfiltered.

Process 1400 may further include a step 1480 of monitoring model performance in the unique environment. During an operational mode, the performance of the system may be periodically, continually, or ad hoc monitored. The performance may include, for example, a score or percentage of how successfully leaks are detected and are distinguished from ambient or background noise in environment 1310.

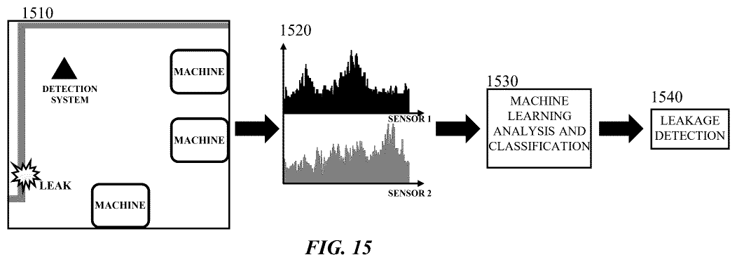

FIG. 15 illustrates an example process block diagram for leakage detection, consistent with the disclosed embodiments. In some embodiments, the system of FIG. 15 may be implemented in environments 100 or 500, or in connection with other systems described above.

As illustrated, an environment may include a detection system, conduits, and a plurality of machines, all as discussed above in various embodiments. Based on sensors in the environment (e.g., microphones or other sensors), data may be collected from the environment in operation 1510. For example, microphones may collect sound data in operation 1510, which may correspond to ambient or background noise in an environment, a leak in a conduit, human voice, or various other sources of sound.

This collected sound data may be analyzed in operation 1520. For example, the sound data may be digitized as discussed above and analyzed as a digital acoustic profile. Operation 1520 may include one or more sensors, such as Sensor 1 and Sensor 2, each collecting different sound data resulting a different acoustic profile.

In operation 1530, the collected sound data may be sent to a machine learning analysis and classification process. This may involve, for example, comparing the sound profiles from Sensor 1 and Sensor 2 to previously stored sound profiles and performing a machine-learning classification process. In operation 1540, a leakage detection may be performed if one of the collected sound profiles is determined to be classified as a leak. As discussed above, the classification may be exact, approximately, based on a probability, etc. The various machine-learning classification techniques discussed above may be used in operation 1540.

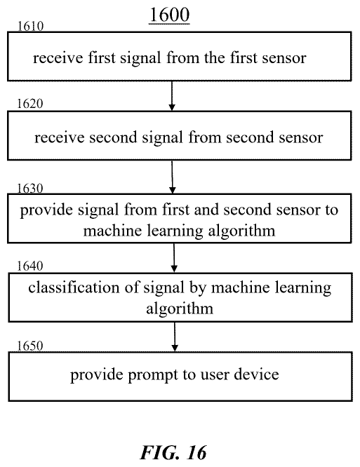

FIG. 16 illustrates an example process 1600 for leakage detection, consistent with the disclosed embodiments. In some embodiments, process 1600 may be carried out by detection system 140, processing unit 240, system 320, detection system 510, processing units 912, 922, 932, processing units 1112, 1122, 1132, or other systems. Consistent with the discussion above, process 1600 may obtain signals from a variety of different types of acoustic sensors, such as sensors 911, 921, 931 or sensors 1111, 1121, 1131. The acoustic sensors may be placed in an environment, such as environments 100 or 500, which may take a variety of different forms. In accordance with the discussion above, process 1600 may be performed locally (e.g., within environment 100 or 500) or externally (e.g., via a separate server).

Process 1600 may include a step 1610 of receiving a first signal from a first sensor. For example, as illustrated in FIG. 15 the first sensor may located in an environment with a conduit and/or machines. The sensor may be located proximate to the conduit in examples where leakages of the conduit are to be detected. The signals may be, as discussed above, acoustic or sound signals.

Process 1600 may also include a step 1620 of receiving a second signal from a second sensor. The second sensor and second signal may be implemented similar to the first sensor and first signal.

Process 1600 may further include a step 1630 of providing a signal from first and second sensors to machine learning algorithm. As illustrated in FIG. 15, Sensor 1 and Sensor 2 may each collect different sounds, and have associated different acoustic profiles. These acoustic profiles may be sent to a machine learning model in operation 1530.

Process 1600 may also include a step 1640 of classifying a signal by machine learning algorithm. As discussed above, various classification techniques may be used for either or both of the first and second signals. The classification may involve comparing the first and second signals to various pre-collected samples to determine a classification (e.g., exactly, approximately, by probability, etc.). Examples of the classification output may include a fault condition, a no-fault condition, a precondition (e.g., fault occurring in the future), or the like.

Process 1600 may further include a step 1650 of providing a prompt to user device. Various types of prompts may be provided to the user device indicative of the output of the classification in step 1640. Examples of the prompt are discussed above in connection with operation 330 of FIG. 3 and step 870 of FIG. 8.

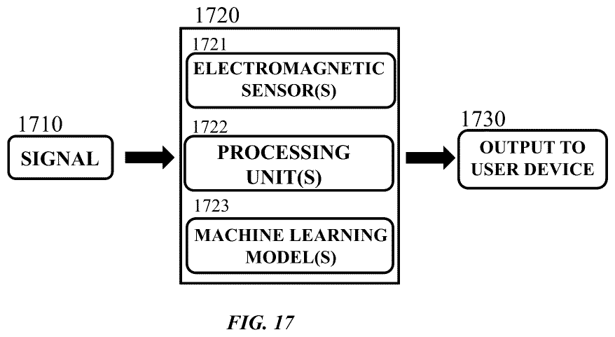

FIG. 17 illustrates an example process block diagram for electromagnetic leakage detection, consistent with the disclosed embodiments. In some embodiments, the system of FIG. 17 may be implemented in environments 100 or 500, or in connection with other systems described above.

In accordance with FIG. 17, various types of equipment may generate electromagnetic signals 1710. Virtually all electronic devices may produce an electromagnetic signal that can be sensed. Examples include factory equipment, computers, servers, laboratory equipment, air conditioning or heating systems, manufacturing equipment, and many other types of devices.

System 1720 may be configured to detect and analyze electromagnetic signals. For example, sensors 1721 may include, as discussed above, induction coils, hall sensors, giant magnetoresistance (GMR) sensors, anisotropic magnetoresistance (AMR) sensors, or the like. Processing unit 1722 may be similar to processing unit 240, processing units 912, 922, 932, processing units 1112, 1122, 1132, or the like, as discussed above. Machine learning models 1723 may be similar to the various models discussed above as well.

System 1720 may be configured to train machine learning models 1723 to classify and differentiate between ambient or regular electromagnetic radiation and anomalous or fault-type electromagnetic radiation. For example, through a machine learning and training, as discussed above, machine learning model 1723 may be able to classify regular, routine, or ambient electromagnetic signals coming from machines in an environment. Also, machine learning model 1723 may be able to classify unusual, anomalous, or erroneous electromagnetic signals. For example, such fault-type signals may arise when a machine overheats, has a broken or loose connection, is operating an unexpected times of day, is operating for unexpected durations, or is otherwise operating in an erroneous manner.

When system 1720 determines, by comparing sensed electromagnetic signals to stored signals via machine learning model 1723, that a fault or error condition exists, system 1720 may generate an output to a user device in operation 1730. The output may take various forms, as discussed above in connection with operation 330 of FIG. 3 and step 870 of FIG. 8. As discussed above, the fault or error may be classified exactly, approximately, or by probability, among other techniques.

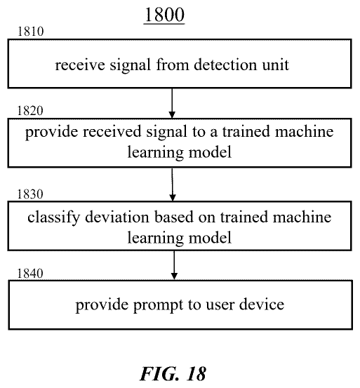

FIG. 18 illustrates an example process 1800 for electromagnetic leakage detection, consistent with the disclosed embodiments. In some embodiments, process 1800 may be carried out by detection system 140, processing unit 240, system 320, detection system 510, processing units 912, 922, 932, processing units 1112, 1122, 1132, or other systems. Consistent with the discussion above, process 1800 may obtain signals from a variety of different types of electromagnetic sensors. The electromagnetic sensors may be placed in an environment, such as environments 100 or 500, which may take a variety of different forms. In accordance with the discussion above, process 1800 may be performed locally (e.g., within environment 100 or 500) or externally (e.g., via a separate server).

Process 1800 may include a step 1810 of receiving a signal from a detection unit. For example, in accordance with FIG. 17 the signal may be signal 1710, an electromagnetic signal.

Process 1800 may also include a step 1820 of providing a received signal to a trained machine learning model. As illustrated in FIG. 17, signal 1710 may be provided to machine learning model 1723, which may be partially or fully trained as discussed above in various embodiments.

Process 1800 may further include a step 1830 of classifying a deviation between the received signal and an electromagnetic baseline based on the trained machine learning model. As discussed above, the machine learning model 1723 may learn the difference between fault and non-fault signals through machine learning training, as discussed above in various embodiments.

Process 1800 may also include a step 1840 of providing a prompt to a user device. The prompt may take various forms, as discussed above in connection with operation 330 of FIG. 3 and step 870 of FIG. 8. For example, a prompt may be delivered to a user device, displayed visually, communicated via an electronic message, sent to another monitoring or security system, or the like.

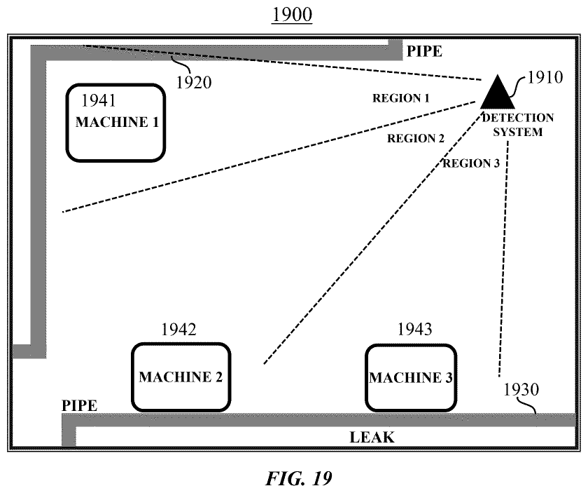

FIG. 19 illustrates an example system environment 1900 for mobile leakage detection, consistent with the disclosed embodiments. In some embodiments, the system of FIG. 19 may be implemented in environments 100 or 500. For example, detection system 1910 may be implemented by detection system 140, processing unit 240, system 320, or detection system 510. As discussed above in various embodiments, environment 1900 may include one or more conduits 1920, 1930, and one or more machines 1941, 1942, 1943.

In FIG. 19, detection system 1910 may be a mobile system. That is, detection system 1910 may move through some or all of environment 1900. In one example, detection system may be a robotic device that is propelled using wheels, tracks, fans, or various other locomotive techniques. Further, in some embodiments detection system 1910 may move along or climb surfaces using suction techniques, such as suction cups. Further, detection system 1910 may potentially be movable connected to conduits 1920, 1930, such as via a track on conduits 1920, 1930, a track near conduits 1920, 1930, or via other connection mechanisms on or near conduits 1920, 1930.

In accordance with these embodiments, detection system 1910 may move throughout environment 1900 according to various triggers or schedules. In one example, detection system 1910 may move in all or selected areas of environment 1900 according to a schedule, or may do so continuously. Further, in some embodiments detection system 1910 may move to particular locations in environment 1900 when sounds are detected in those locations, when anomalous sounds are detected in those locations, or when other physical anomalies are detected in those locations (e.g., via motion sensors, microphones, light sensors, etc.).

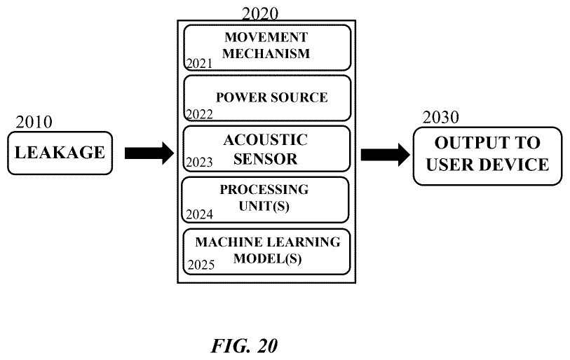

FIG. 20 illustrates an example process block diagram for mobile leakage detection, consistent with the disclosed embodiments. In accordance with FIG. 19, a leakage may be detected in environment 1900 in an operation 2010. Data indicative of the leakage (e.g., acoustic data) may be transmitted to system 2020 as discussed above in various embodiments. System 2020 may include a movement mechanism, which may include components such as propellers, wheels, tracks, suction cups, etc. System 2020 may further include a power source 2022 to provide energy (e.g., electrical energy) for operation of movement mechanism 2021. Power source 2022 may be, for example, a battery, a local power supply, a kinetic energy harvesting device, etc. System 2020 may further include one or more acoustic sensors 2023, processing units 2024, and machine learning models 2025, all as discussed above in various embodiments.

Outputs 2030 of system 2030 may be provided to a user device in various ways, as discussed above. For example, the output may take various forms, as discussed above in connection with operation 330 of FIG. 3 and step 870 of FIG. 8.

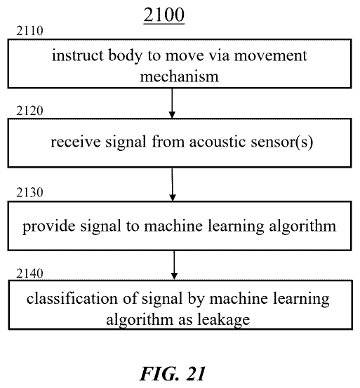

FIG. 21 illustrates an example process 2100 for mobile leakage detection, consistent with the disclosed embodiments. In some embodiments, process 2100 may be carried out by detection system 140, processing unit 240, system 320, detection system 510, processing units 912, 922, 932, processing units 1112, 1122, 1132, or other systems.

Process 2100 may include a step 2110 of instructing a body to move via a movement mechanism. For example, as shown in FIG. 20, system 2020's processing unit 2024 may instruct a body (e.g., a physical unit housing all or part of system 2020) to move. The instruction may include coordinates (e.g., x-y-z, or the like) in an environment, proximity to a particular location or machine or conduit, or other location information. Alternatively, the instruction may not include location information but rather include instructions for the body to move according to a path or randomly in an environment. As another alternative, the instruction may be to move according to a detected signal (e.g., a detected sound signal in the environment). The movement mechanism 2021 may take various forms, as discussed above.

Process 2100 may also include a step 2120 of receiving a signal from one or more acoustic sensors. In some embodiments, the signal may be received continuously or periodically while the body is moving. Alternatively, the signal may be received only when the body has reached its destination according to the movement instruction received in step 2110.

Process 2100 may further include a step 2130 of providing a signal to a machine learning algorithm. As discussed above in various embodiments, the signal may be an acoustic or audio signal captured by acoustic sensor 2023 of system 2020.

Process 2100 may also include a step 2140 of classifying a signal by a machine learning algorithm as leakage. The classification may be performed by machine learning model 2025, in accordance with various techniques discussed above. For example, the classification may be fault, no-fault, precondition for a fault, or various others.

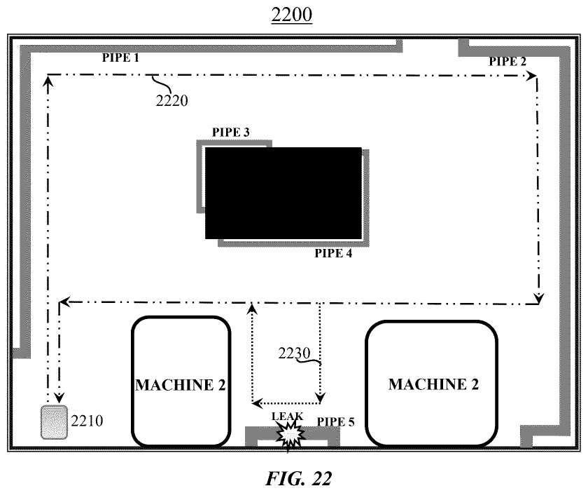

FIG. 22 illustrates an example system environment 2200 for leakage classification, consistent with the disclosed embodiments. In some embodiments, the system of FIG. 22 may be implemented in environments 100 or 500, or various others. Environment 2200 may include one or more conduits (e.g., Pipe 1, Pipe 2, Pipe 3, Pipe 4, Pipe 5), one or more machines (e.g., Machine 1, Machine 2), and a movable device 2210 (e.g., detection system 1910 from FIG. 19, or system 2020 from FIG. 20).

FIG. 22 also illustrates exemplary paths 2220, 2230 that movable device 2210 may take throughout environment 2200. As discussed above, movable device 2210 may move according to these paths via movement mechanism 2021, powered by power source 2022. Maps or navigation coordinates for the movements may be stored in system 2020 and carried out by processing unit 2024.

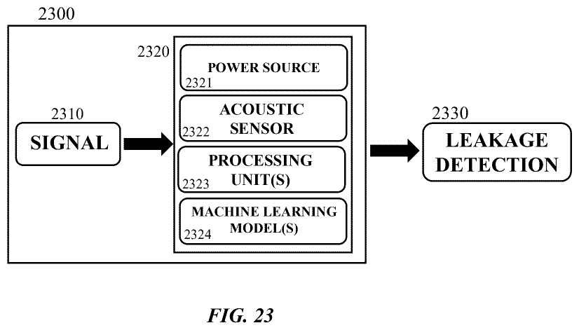

FIG. 23 illustrates an example process block diagram 2300 for leakage classification, consistent with the disclosed embodiments. In accordance with FIG. 23, a movable device powered by power source 2321 may receive a signal 2310 (e.g., acoustic signal) via one or more acoustic sensors 2322. The signal may be processed via processing unit 2323 and provided to a machine learning model 2324, in accordance with above embodiments. As discussed above, a leakage detection operation 2330 may be performed when a leakage is detected by machine learning model 2324.

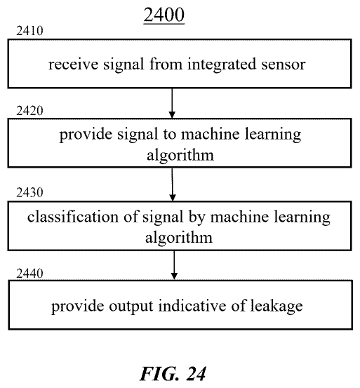

FIG. 24 illustrates an example process 2400 for leakage classification, consistent with the disclosed embodiments. In some embodiments, process 2100 may be carried out by detection system 140, processing unit 240, system 320, detection system 510, processing units 912, 922, 932, processing units 1112, 1122, 1132, or other systems.

Process 2400 may include a step 2410 of receiving a signal from an integrated sensor. For example, the movable device may gather and transmit acoustic signals from an environment either continuously, periodically, according to a schedule, according to an event being detected, according to a location being reached, etc. The integrated sensor may be part of the movable body itself, attached to it, or the like.

Process 2400 may also include a step 2420 of providing a signal to a machine learning algorithm. For example, the signal 2310 may be provided to machine learning model 2324, as discussed above in various embodiments.

Process 2400 may further include a step 2430 of classifying a signal by a machine learning algorithm. The classification may be performed by machine learning model 2324 using various techniques, as discussed above.

Process 2400 may also include a step 2440 of providing an output indicative of a leakage. For example, the output may take various forms, as discussed above in connection with operation 330 of FIG. 3 and step 870 of FIG. 8.

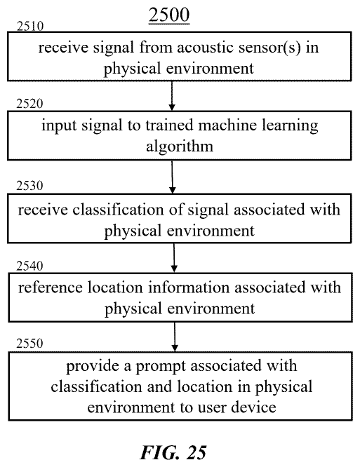

FIG. 25 illustrates an example process 2500 for leakage localization, consistent with the disclosed embodiments. In some embodiments, process 2500 may be carried out by detection system 140, processing unit 240, system 320, detection system 510, processing units 912, 922, 932, processing units 1112, 1122, 1132, or other systems.

Process 2500 may include a step 2510 of receiving a signal from one or more acoustic sensors in a physical environment. For example, in accordance with above embodiments one or more acoustic sensors (e.g., microphones) may be deployed throughout an environment. The acoustic sensors may be configured to gather acoustic data associated with leakages in conduits (e.g., pipes, etc.).

Process 2500 may also include a step 2520 of inputting a signal to a trained machine learning algorithm. The signals gathered by the acoustic sensors may be input to a trained machine learning algorithm. As discussed above, the algorithm may be trained according to a variety of techniques. Once trained, the algorithm may be able to classify or differentiate between fault (e.g., leakage), no-fault (e.g., no leakage), or precondition (e.g., leakage building) conditions.

Process 2500 may further include a step 2530 of receiving a classification of a signal associated with a physical environment. In accordance with above embodiments, the classification may be performed to yield various results, such as fault (e.g., leakage), no-fault (e.g., no leakage), or precondition (e.g., leakage building).

Process 2500 may also include a step 2540 of referencing location information associated with a physical environment. The location information may be obtained in various ways. For example, when an acoustic sensor provides a signal that is classified as a fault (e.g., leakage) condition, the location of the sensor may be provided. Alternatively, when the sensor is performing in a beamforming arrangement, the location of the sound source being focused on may be provided. Further, in embodiments where the sensor is embodied in a movable device (e.g., in accordance with FIGS. 19, 20, 21, 22, 23, 24), the location of the movable device may be provided. In accordance with above embodiments, the location may be expressed as coordinates (e.g., x-y-z), location on a map of a facility, location relative to other components in the facility, etc.

Process 2500 may further include a step 2550 of providing a prompt associated with a classification and a location in a physical environment to a user device. For example, the prompt may take various forms, as discussed above in connection with operation 330 of FIG. 3 and step 870 of FIG. 8. In process 2500, the prompt may also indicate where the detected leakage is occurring. For example, this may be expressed textually (e.g., identifying a conduit, machine, facility, etc. by name), in terms of coordinates, in terms of a visual location on a map of a facility, etc.

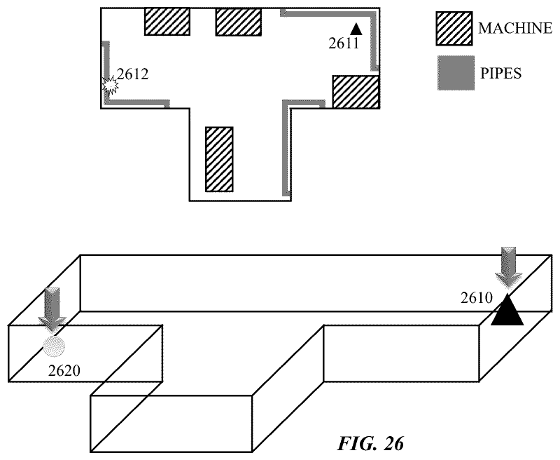

FIG. 26 illustrates an example system environment for leakage detection sensor placement, consistent with the disclosed embodiments. In some embodiments, the system of FIG. 26 may be implemented in environments 100 or 500, or various others. The environment of FIG. 26 may include one or more conduits 2611, 2612, one or more machines, and one or more acoustic sensors 2620, 2610.

As illustrated in FIG. 26, a leakage 2612 may arise in one conduit but a no-fault condition 2611 may occur in another conduit. In such a situation, sensor 2620 may detect a leakage while sensor 2610 may not. While sensor 2620 may detect a leakage, however, various performance criteria may indicate that sensor 2620 is not in an optimum location for such detection. For example, the amplitude of the detected signal associated with leak 2612 may be weak, may be distorted, or may be affected by system noise. In such situations, it may be desirable to improve the location of sensor 2620. This may be accomplished if other sensors are also able to detect leakage 2612 with either greater or less performance. For example, if another sensor is able to detect leakage 2612 with greater signal strength, less distortion, or less noise, it may be in a superior position relative to sensor 2620. With additional sensors, this may lead to further enhanced improvement regarding the location of sensors relative to leakage 2612.

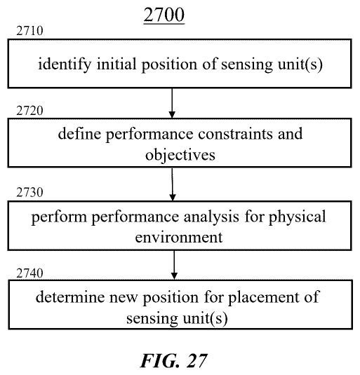

FIG. 27 illustrates an example process 2700 for leakage detection sensor placement, consistent with the disclosed embodiments. In some embodiments, process 2700 may be carried out by detection system 140, processing unit 240, system 320, detection system 510, processing units 912, 922, 932, processing units 1112, 1122, 1132, or other systems.

In process 2700, step 2710 may include identifying initial positions of one or more sensing units. The initial positions may be expressed as coordinates, relative locations, or various other forms, as discussed above.

Further, step 2720 may include defining performance constraints and objectives. In some embodiments, the performance constraints may include minimum levels of signal strength (e.g., decibels, digitized strength, etc.), signal-to-noise ratio, etc.

Also, step 2730 may include performing a performance analysis for a physical environment. The performance analysis may include determining which among a plurality of microphones that have detected the same signal have the strongest performance (e.g., in terms of signal strength, lack of noise, etc.).

Further, step 2740 may include determining new positions for placement of the one or more sensing units. For example, this may include selecting one or more microphones based on the result of step 2730. In particular, one or more microphones with superior signal strength, lack of noise, or the like may be selected as optimum locations. Further, when multiple microphones are used in the analysis, a hypothetical location where no microphone yet is placed may be determined as the optimum location for a microphone. This location may be determined by comparing results from two or more other microphones in different locations and comparing their performance results. The comparison may be exact, approximately, or probability-based, etc.

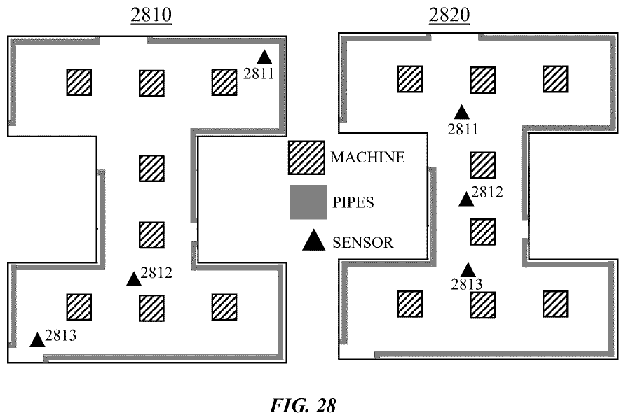

FIG. 28 illustrates an example system environment for improved leakage detection sensor placement, consistent with the disclosed embodiments. In some embodiments, the system of FIG. 28 may be implemented in environments 100 or 500, or various others. The environment of FIG. 28 may include one or more conduits, one or more machines, and one or more acoustic sensors 2811, 2812, 2813. According to the techniques of FIGS. 26 and 27, initial sensor placements may be located as shown in environment 2810. But based on the results of process 2700, new and improved sensor locations may be recommended, identified, or selected as shown in environment 2820.

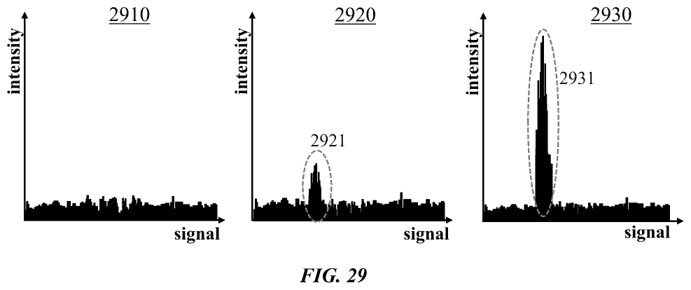

FIG. 29 illustrates example pre-leakage detection signal-to-intensity graphs, consistent with the disclosed embodiments. In some embodiments, the graphs shown may result from sensors implemented in environments 100 or 500, or various others, as discussed above.

As illustrated, graph 2910 may indicate a no-fault condition, graph 2920 may indicate a pre-condition fault condition, and graph 2930 may indicate a fault condition. The graphs may be expressed in terms of signal to intensity (e.g., frequency compared to signal strength), although other expressions are possible as well. Through the machine learning techniques discussed above, the progression from graph 2910 to graph 2920 (or solely based on classification of graph 2920 itself), a machine learning model may determine that a pre-condition for a leak is occurring in a conduit. In particular, the growing anomaly 2921 may be indicative of a pre-condition of a leak. Similarly, the progression from graph 2920 to graph 2930 (or solely based on classification of graph 2930 itself), a machine learning model may determine that a leak has occurred in a conduit. Here, the anomaly 2931 may be indicative of an actual leak. In accordance with various above embodiments, the leakage and pre-condition may be associated with various conditions, such as excessive pressure of a fluid, a broken or faulty seal or sleeve, corrosion, cracks or holes, loose connections, open or defective faucets or nozzles, damaged joints, excessive heat or cold, and various other circumstances.

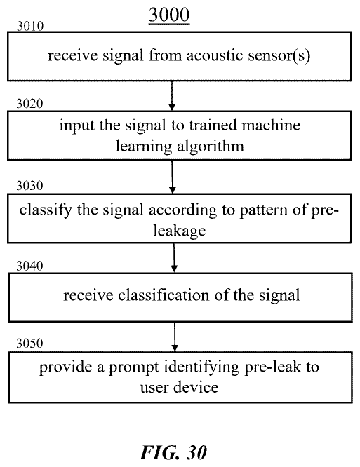

FIG. 30 illustrates an example process 3000 for pre-leakage detection, consistent with the disclosed embodiments. In some embodiments, process 3000 may be carried out by detection system 140, processing unit 240, system 320, detection system 510, processing units 912, 922, 932, processing units 1112, 1122, 1132, or other systems.

Process 3000 may include a step 3010 of receiving a signal from one or more acoustic sensors. This may be accomplished according to the various embodiments discussed above, such as via microphones located in an environment being monitored.

Process 3000 may also include a step 3020 of inputting the signal to a trained machine learning algorithm. This may also be performed as described above in the various embodiments.

Process 3000 may further include a step 3030 of classifying the signal according to a pattern of pre-leakage. Likewise, this step 3030 may be performed utilizing the techniques discussed above in various embodiments.

Process 3000 may also include a step 3040 of receiving a classification of the signal. This step too may be performed using the techniques discussed above in various embodiments.

Process 3000 may further include a step 3050 of providing a prompt identifying a pre-leak to a user device. For example, the prompt may be triggered when a precondition such as signal 2921 is detected, as discussed above in connection with FIG. 29.

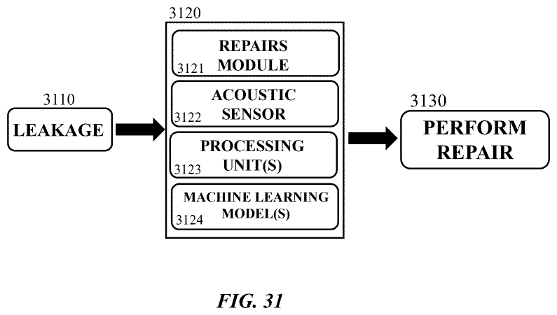

FIG. 31 illustrates an example process block diagram for repairing leakages, consistent with the disclosed embodiments. In accordance with FIG. 31, a leakage may be detected in an environment in an operation 3110. Data indicative of the leakage (e.g., acoustic data) may be transmitted to system 3120 as discussed above in various embodiments. System 3120 may include a repairs module 3121, as discussed further below. System 3120 may further include one or more acoustic sensors 3122, processing units 3123, and machine learning models 3124, all as discussed above in various embodiments.

As shown in FIG. 31, repairs module 3121 may carry out repair operation 3130. This may occur, for example, when a leakage is detected in operation 3110 and a repair of the leakage is warranted. Repairs module 3121 may take several forms. For example, repairs module 3121 may be configured to apply an epoxy (e.g., pure epoxy, polyester resins, epoxy acrylates, etc), apply an adhesive (e.g., polyurethane, silicone, silane modified polymer (SMP), butylpolysulfide, marine, etc.), apply nanoparticles (e.g., titanium dioxide (TiO2) nanoparticles, metal nanoparticles, silver nanoparticles, dendrimers, silica nanoparticles, etc.), or apply various other types of sealants or solvents to remedy a leakage.

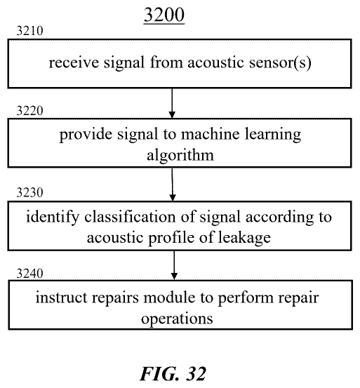

FIG. 32 illustrates an example process 3200 for repairing leakages, consistent with the disclosed embodiments. In some embodiments, process 3200 may be carried out by detection system 140, processing unit 240, system 320, detection system 510, processing units 912, 922, 932, processing units 1112, 1122, 1132, or other systems.

Process 3200 may include a step 3210 of receiving a signal from one or more acoustic sensors. For example, acoustic sensors 3122 may obtain acoustic data from an environment, as discussed above in various embodiments.

Process 3200 may also include a step 3220 of providing a signal to a machine learning algorithm. As discussed above, the signal may be provided to machine learning model 3124, in accordance with various above embodiments.

Process 3200 may further include a step 3230 of identifying a classification of a signal according to an acoustic profile of a leakage. This classification may be performed according to the various machine learning techniques discussed above.

Process 3200 may also include a step 3240 of instructing a repairs module to perform repair operations. In accordance with FIG. 31, for example, repairs module 3121 may, via instructions from processing unit 3123, cause one or more repairs to be performed. This may include, for instance, applying a material to a conduit to fix a leakage or other condition. For example, repairs module 3121 may apply to a conduit, where a leakage is detected, an epoxy (e.g., pure epoxy, polyester resins, epoxy acrylates, etc), an adhesive (e.g., polyurethane, silicone, silane modified polymer (SMP), butylpolysulfide, marine, etc.), nanoparticles (e.g., titanium dioxide (TiO2) nanoparticles, metal nanoparticles, silver nanoparticles, dendrimers, silica nanoparticles, etc.), or various other types of sealants or solvents to remedy the leakage.

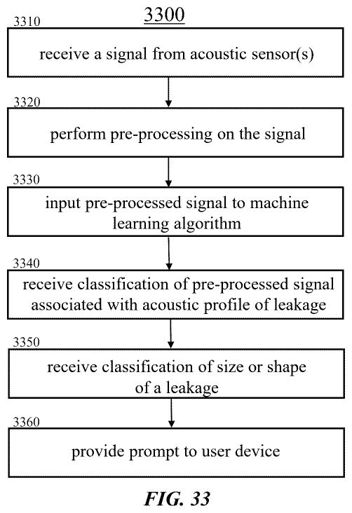

FIG. 33 illustrates example process 3300 for determining estimated classifications of leakages, consistent with the disclosed embodiments. In some embodiments, process 3300 may be carried out by detection system 140, processing unit 240, system 320, detection system 510, processing units 912, 922, 932, processing units 1112, 1122, 1132, or other systems.

Process 3300 may include a step 3310 of receiving a signal from one or more acoustic sensors. The signal may be collected from the one or more sensors as discussed above in various embodiments.

Process 3300 may also include a step 3320 of performing pre-processing on the signal. The pre-processing may take several forms, as discussed above in various embodiments.

Process 3300 may further include a step 3330 of inputting a pre-processed signal to a machine learning algorithm. The inputting of the signal to a machine learning algorithm is also discussed above in various embodiments.

Process 3300 may also include a step 3340 of receiving a classification of the pre-processed signal associated with an acoustic profile of a leakage. The classification (e.g., fault, no-fault, pre-condition for a fault, etc.) is also discussed above in various embodiments.

Process 3300 may further include a step 3350 of receiving a classification of a size or shape of a leakage. In accordance with FIG. 33, the machine learning model may be trained to not only detect a leakage status (e.g., fault, no-fault, or pre-condition), but may further be precisely trained to detect a size or shape of a leakage. As an example, a different acoustic profile may result from an open conduit (e.g., complete break) versus corrosion of the conduit. Further, a different acoustic profile may arise from a broken seal on a conduit compared to a loose valve on a conduit. Similarly, different acoustic profiles may arise from a hairline fracture (e.g., <1 mm) in a conduit, a small puncture (e.g., 1-5 mm) in the conduit, a large puncture (e.g., >5 mm) in the conduit, and a complete opening or breakage of the conduit. The machine learning algorithm may be trained according to the above techniques to classify and differentiate between these different types of sizes and/or shapes of leakages.

Process 3300 may also include a step 3360 of providing a prompt to a user device. In this step, as discussed above, various types of prompts may be provided to a user, such as those discussed above in connection with operation 330 of FIG. 3 and step 870 of FIG. 8. Further, in some embodiments the prompt may indicate (e.g., textually, graphically, locationally on a map, or visually) the size or shape of the leakage determined in step 3350.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the figures illustrate the architecture, functionality, and operation of possible implementations of systems, methods and computer program products according to various embodiments of the present disclosure. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A system for acoustically detecting leakage of a fluid, comprising:
one or more acoustic sensors; and
at least one processing unit configured to:
receive a signal from the one or more acoustic sensors;
perform pre-processing on the signal, the pre-processing including
at least one of:
signal mixing,
signal augmentation,
signal time characteristic extraction,
signal filtration,
signal Fourier transformation,
feature extraction pipeline,
dimensionality reduction mechanism, or
signal spectral analysis;
input the pre-processed signal to a machine learning algorithm, the machine learning algorithm having been trained using training data at least partially collected within a particular physical environment;
receive, based on the pre-processed signal and the machine learning algorithm, a classification of the pre-processed signal, the classification being associated with an acoustic profile of leakage of a fluid and indicating at least a direction of source of the leakage of the fluid in the particular physical environment relative to the one or more acoustic sensors; and
cause an output provide a prompt associated with the classification to be displayed on a user device, the output indicating the direction of the source of the leakage of the fluid in the particular physical environment relative to the one or more acoustic sensors.

2. The system of claim 1, wherein the at least one acoustic sensor is configured to dynamically change its orientation.

3. The system of claim 1, wherein the machine learning algorithm comprises a deep learning algorithm.

4. The system of claim 1, wherein the processing unit is further configured to identify, based on the pre-processed signal and the machine learning algorithm a location of the leakage of the fluid in the particular physical environment.

5. The system of claim 4, wherein the output further includes an indication of the location of the leakage of the fluid in the particular physical environment.

6. The system of claim 1, wherein the machine learning algorithm is uniquely trained for the particular physical environment.

7. The system of claim 1, wherein the machine learning algorithm is a generalized algorithm tuned to the particular physical environment.

8. The system of claim 1, wherein the output is at least one of a message, graphical user interface content, or data sent to a different system.

9. The system of claim 1, wherein the processing unit is configured to receive a plurality of signals from a plurality of acoustic sensors.

10. The system of claim 1, wherein fluid is a pressurized gas.

11. A computer-implemented method for acoustically detecting leakage of a fluid using one or more acoustic sensors, the method comprising:
receiving a signal from the one or more acoustic sensors;
performing pre-processing on the signal, the pre-processing including at least one of:
signal mixing,
signal augmentation,
signal time characteristic extraction,
signal filtration,
signal Fourier transformation,
feature extraction pipeline,
dimensionality reduction mechanism, or
signal spectral analysis;
inputting the pre-processed signal to a machine learning algorithm, the machine learning algorithm having been trained using training data at least partially collected within a particular physical environment;
receiving, based on the pre-processed signal and the machine learning algorithm, a classification of the pre-processed signal, the classification being associated with an acoustic profile of leakage of a fluid and indicating at least a direction of source of the leakage of the fluid in the particular physical environment relative to the one or more acoustic sensors; and
causing an output associated with the classification to be displayed on a user device, the output indicating the direction of the source of the leakage of the fluid in the particular physical environment relative to the one or more acoustic sensors.

12. The computer-implemented method of claim 11, wherein the at least one acoustic sensor is configured to dynamically change its orientation.

13. The computer-implemented method of claim 11, wherein the machine learning algorithm comprises a deep learning algorithm.

14. The computer-implemented method of claim 11, further comprising identifying, based on the pre-processed signal and the machine learning algorithm a location of the leakage of the fluid in the particular physical environment.

15. The computer-implemented method of claim 14, wherein the output further includes an indication of the location of the leakage of the fluid in the particular physical environment.

16. The computer-implemented method of claim 11, wherein the machine learning algorithm is uniquely trained for the particular physical environment.

17. The computer-implemented method of claim 11, wherein the machine learning algorithm is a generalized algorithm tuned to the particular physical environment.

18. The computer-implemented method of claim 11, wherein the output is at least one of a message, graphical user interface content, or data sent to a different system.

19. The computer-implemented method of claim 11, further comprising receiving a plurality of signals from a plurality of acoustic sensors.

20. The computer-implemented method of claim 11, wherein fluid is a pressurized gas.

21. The system of claim 1, wherein the particular physical environment is a space within a building.
